(19) United States
(12) Patent Application Publication
(10) Pub. No.: US 2022/0048121 A1
(43) Pub. Date: Feb. 17, 2022

(54) ULTRASONIC BLADE FOR CUTTING A METAL

(71) Applicant: Sion Power Corporation, Tucson, AZ (US)

(72) Inventors: David Child, Tucson, AZ (US); Troy Shannon, Tucson, AZ (US); Michael G. Laramie, Tucson, AZ (US)

(73) Assignee: Sion Power Corporation, Tucson, AZ (US)

(21) Appl. No.: 17/397,114

(22) Filed: Aug. 9, 2021

Related U.S. Application Data
(60) Provisional application No. 63/064,788, filed on Aug. 12, 2020.

(51) Int. Cl. B23D 15/04; H01M 4/1395; B23D 35/00

(52) U.S. Cl. CPC B23D 15/04; H01M 2004/028; B23D 35/001; H01M 4/1395

(57) ABSTRACT

Systems and methods related to cutting (e.g., ultrasonically cutting) metals (e.g., lithium metal) and electrode precursors are generally provided. The electrodes or electrode precursors may involve, for example, a lithium metal electrode or a lithium composite electrode, e.g., for use in an electrochemical cell or battery.

### RELATED APPLICATIONS

This application claims priority to U.S. Provisional Application No. 63/064,788, filed Aug. 12, 2020, which is incorporated herein by reference in its entirety.

### TECHNICAL FIELD

Systems and methods for ultrasonically cutting metals, such as lithium metal, are generally described.

### SUMMARY

Systems and methods for ultrasonically cutting metals, such as lithium metal, are generally described. The subject matter of the present invention involves, in some cases, interrelated products, alternative solutions to a particular problem, and/or a plurality of different uses of one or more systems and/or articles.

In one aspect, a system for cutting a metal electrode is described comprising a blade, an ultrasonic resonator connected to the blade, and a metal to be cut comprising a Young's modulus less than or equal to 130 GPa.

In another aspect, a system for cutting a metal electrode is described comprising a blade, an anvil adjacent to the blade, an ultrasonic resonator connected to the blade or the anvil, and the metal positioned between the blade and the anvil.

In another aspect, an electrode is described comprising a first polymeric layer, a second polymeric layer, an electroactive material layer comprising a metal, wherein the electroactive material layer comprises a top surface, a bottom surface, and a side surface between the top and bottom surfaces, wherein the top surface is adjacent the first polymeric layer, the bottom surface is adjacent the second polymeric layer, and wherein at least a portion of the first polymeric layer and/or at least a portion of the second polymeric layer covers at least a portion of the side surface of the electroactive material layer.

In yet another aspect, a method of cutting a metal electrode is described, the method comprising, positioning the metal between an anvil and a blade, wherein the blade or the anvil is connected to an ultrasonic resonator, and ultrasonically cutting the metal with the blade.

In yet another aspect, a method of forming an electrode stack is described, the method comprising positioning a metal between an anvil and a blade, wherein the blade or the anvil is connected to an ultrasonic resonator, positioning a first polymeric layer above the metal, positioning a second polymeric layer below the metal, and ultrasonically cutting the first polymeric layer, the metal, and the second polymeric layer.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A is a schematic diagram of an ultrasonic resonator that can move along a z-axis, an x-axis, and a y-axis and can provide ultrasonic motion, according to some embodiments;

FIG. 1B shows a schematic diagram of an ultrasonic resonator with an attached blade such that the ultrasonic resonator provides motion to the blade along a z-axis, an x-axis, and a y-axis, according to some embodiments;

FIG. 1C is a schematic diagram of an anvil configured for ultrasonic resonation wherein the attached ultrasonic resonator provides motion to the anvil along a z-axis, an x-axis, and a y-axis, wherein a perpendicular axis between the blade and the anvil is shown that is parallel to the z-axis, according to some embodiments;

FIGS. 2A-2B are schematic illustrations of a blade in the form of a die that can cut a metal with a closed shape, according to some embodiments;

FIG. 2C schematically shows a die configured for ultrasonic resonation, according to one set of embodiments;

FIGS. 3A-3D schematically depict systems and methods for ultrasonically cutting a metal with a die, according to some embodiments;

FIG. 3E is schematic of a system for cutting a metal with a polymeric layer disposed above the metal, according to one embodiment;

FIG. 3F is schematic of a system for cutting a metal with a polymeric layer disposed below the metal, according to one embodiment;

FIG. 3G is a schematic of a system for cutting a metal with polymeric layer disposed above and below the metal, according to one set of embodiments;

FIG. 4A is a schematic illustration of a system and method for cutting two polymeric layers and a metal with a die, according to some embodiments;

FIG. 4B is a schematic diagram of an article comprising two polymeric layers conformally enveloping at least a portion of a metal formed by the system and method shown in FIG. 4A, according to some embodiments;

FIGS. 5A-5B schematically depict systems and methods for ultrasonically cutting a metal with a blade without cutting a polymeric layer, according to one set of embodiments;

FIGS. 6A-6B are schematic diagrams of a blade for cutting a metal and a polymeric layer adjacent the metal, according to some embodiments;

FIGS. 6C-6D are schematic illustrations of a system and method for ultrasonically cutting through a first interleaf layer and an electrode assembly, according to some embodiments;

FIGS. 7A-7C schematically depict an electrode assembly with a release layer that can be ultrasonically cut, according to some embodiments;

FIG. 8 is a schematic illustration of a blade adhering a polymeric layer to form an electrode precursor, according to some embodiments;

FIG. 9A is a photographic image of a die connected to an ultrasonic resonator that has been used to ultrasonically cut a metal foil adjacent to an anvil, according to one embodiment; and

FIGS. 9B-9C are photographic images of a metal ultrasonically cut in a closed shape of a die, according to one set of embodiments.

### DETAILED DESCRIPTION

Systems and methods related to ultrasonically cutting metals are generally provided. In some embodiments, the metal comprises a soft metal, such as lithium metal. Systems and methods for forming electrodes and electrode precursors are also provided. The electrodes or electrode precursors may involve, for example, a lithium metal electrode or a lithium composite electrode. In some embodiments, the ultrasonically cut metal can be used in an electrochemical cell or a Li-ion battery.

Soft metals, such as lithium metal can function as electrode materials in electrochemical cells and batteries. Bulk lithium can be purchased commercially as a solid suspension in oil or as a foil. It can also be deposited on to a substrate using a variety of techniques, such as vapor deposition, vacuum deposition, or molecular beam epitaxy techniques. However, in order to fit the dimensions for a particular electrochemical application, the bulk lithium may require cutting.

However, cutting metals, such as lithium metal, can present several challenges. For example, lithium metal is soft and malleable such that when it is cut, it may be sticky and adhere to the cutting instrument (e.g., a knife, a blade, a die). This can present difficulties when cutting multiple pieces of lithium metal in succession with a cutting instrument because cleaning the cutting instrument in between each cut can slow down the process of preparing electrodes and can also dull the cutting instrument. Cutting lithium metal can also produce excess waste because each cut can accumulate lithium metal on the cutting instrument that, therefore, cannot be used in battery fabrication. Certain existing lithium metal cutting systems attempt to circumvent this issue by positioning the lithium metal between interleafs so that the lithium metal does not directly contact the cutting instrument. However, even in such existing systems, the lithium can still undesirably adhere to the interleafs, making subsequent removal of the lithium from the interleafs difficult.

To circumvent the above challenges, the Inventors have recognized and appreciated that use of an ultrasonic cutting system may provide several advantages over certain existing systems for cutting metals (e.g., a soft metal, lithium metal). For example, a blade or a die may be configured with an ultrasonic resonator that can provide a cleaner cut to the metal when compared to cutting with a blade or a die without an ultrasonic resonator. A cleaner cut reduces the amount of the metal that may adhere to the blade or die after cutting. Additionally, a cleaner cut, as provided by a blade or die with ultrasonic cutting, may allow for multiple, repeated cuts in succession while reducing the amount of metal waste produced when compared to a blade or die without an ultrasonic resonator. Furthermore, the edges of the ultrasonically cut metal can be smoother and less jagged than metals cut with certain existing systems, which can reduce tearing and/or damaging other components (e.g., a polymeric layer, a battery separator) of an electrochemical cell.

Accordingly, systems and methods described herein may include an ultrasonic resonator when cutting a metal (e.g., a soft metal, lithium metal). In some embodiments, the ultrasonic resonator may include a transducer, which may include one or more piezoelectric crystals bound between two or more solid objects that oscillates when a voltage is applied to the piezoelectric crystal(s). The transducer and an anvil, or the transducer and a blade (e.g., a die), may be coupled together to form a monolithic unit (e.g., a horn). The ultrasonic resonator can provide agitation to the metal while the metal is being cut to reduce, minimize, or eliminate the metal from sticking to a cutting instrument (e.g., a blade). The ultrasonic resonator can provide, in some embodiments, ultrasonic frequencies (e.g., greater than or equal to 20 kHz) or ultrasonication.

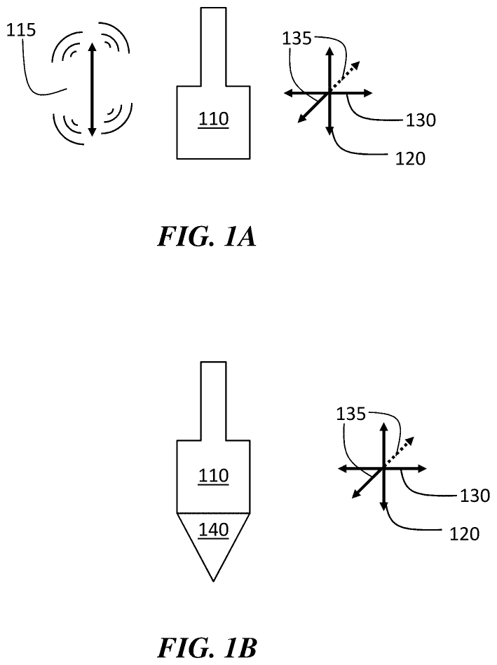

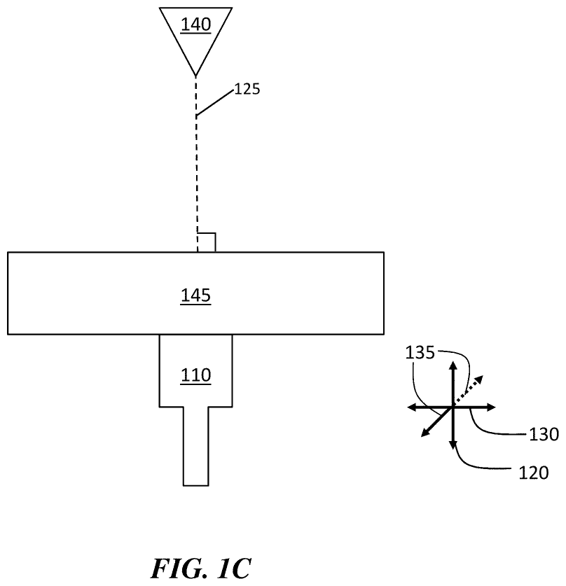

In some embodiments, the ultrasonic resonator is configured to move in at least one dimension (e.g., in two dimensions, three dimensions). For example, in relation to FIG. 1A, an ultrasonic resonator 110 may provide motion along a z-axis 120, an x-axis 130, or a y-axis 135. The ultrasonic resonator can provide ultrasonic motion in each of these dimensions or a combination of these dimensions. In FIG. 1A, ultrasonic resonator 110 provides ultrasonic motion 115, which is parallel to z-axis 120. However, in some embodiments, the ultrasonic resonator may also provide ultrasonic motion along x-axis 130 and/or y-axis 135.

The ultrasonic resonator can be connected to a blade (e.g., a die). For example, as shown in illustratively FIG. 1B, a blade 140 is connected (e.g., connected directly, connected via a screw) to ultrasonic resonator 110. When the blade is connected to the ultrasonic resonator, the ultrasonic resonator can provide motion to the blade. In FIG. 1B, blade 140 can move along z-axis 120, x-axis 130, and/or y-axis 135. This motion can be used for ultrasonically cutting a metal (e.g., a soft metal) with the blade. In other embodiments, the ultrasonic resonator can be connected indirectly (e.g., via another component such as a shaft or a structure) to the blade. In some embodiments, the ultrasonic resonator and the blade form one, monolithic or integral unit.

In some embodiments, the ultrasonic resonator is connected to an anvil of the ultrasonic cutting system. For example, referencing FIG. 1C, ultrasonic resonator 110 is connected to an anvil 145. The anvil may have a flat portion or a flat surface (e.g., a flat plate) so that a blade (e.g., a die) can be pressed towards or against the anvil to facilitate cutting of a metal. As will be described further below, a polymeric layer (e.g., an interleaf layer) may be positioned adjacent to anvil to prevent the blade from making direct contact with the anvil while cutting. Just as when connected to the blade, when the ultrasonic resonator is connected to the anvil, the ultrasonic resonator can provide motion (e.g., motion in at least one dimension) to the anvil. As shown illustratively in FIG. 1C, ultrasonic resonator 110 can provide motion to anvil 145 along z-axis 120, x-axis 130, and/or y-axis 135. Thus, a system for cutting a metal can comprise blade 140, anvil 145, and an ultrasonic resonator 110 connected (e.g., directly or indirectly) to the anvil in some embodiments. The tip of blade 140 can form a perpendicular axis 125 with the surface of anvil 145. Perpendicular axis 125 can be parallel to z-axis 120, as shown in FIG. 1C. In this manner, the ultrasonic resonator can be configured to move in an axis perpendicular to the anvil and the blade.

The ultrasonic resonator and/or system for cutting a metal can provide ultrasonic resonation at a variety of frequencies. For example, as mentioned above, the ultrasonic resonator and/or system for cutting a metal may operate at a frequency of greater than or equal to 20 kHz. In some embodiments, the ultrasonic resonator and/or system for cutting a metal operates at a frequency of greater than or equal to 15 kHz, greater than or equal to 20 kHz, greater than or equal to 25 kHz, greater than or equal to 30 kHz, greater than or equal to 35 kHz, greater than or equal to 40 kHz, greater than or equal to 45 kHz, or greater than or equal to 50 kHz. In some embodiments, the ultrasonic resonator and/or system for cutting a metal operates at a frequency of less than or equal to 50 kHz. In some embodiments, the ultrasonic resonator and/or system for cutting a metal operates at a frequency of less than or equal to 45 kHz, less than or equal to 40 kHz, less than or equal to 35 kHz, less than or equal to 30 kHz, less than or equal to 25 kHz, less than or equal to 20 kHz, or less than or equal to 15 kHz. Combinations of the above-reference ranges are also possible (e.g., greater than or equal to 20 kHz and less than or equal to 50 kHz). Other ranges are possible.

The ultrasonic resonator and/or system for cutting a metal may be configured to provide a particular amplitude to the blade (e.g., the die) or the anvil. The amplitude can be provided to the system for cutting the metal, including the die. For example, the ultrasonic resonator can be configured to provide the system for cutting, including the die, an amplitude of 10 microns. In some embodiments, the ultrasonic resonator and/or system for cutting a metal is configured to provide an amplitude of greater than or equal to 10 microns, greater than or equal to 15 microns, greater than or equal to 20 microns, greater than or equal to 25 microns, greater than or equal to 30 microns, greater than or equal to 40 microns, greater than or equal to 50 microns, greater than or equal to 60 microns, greater than or equal to 70 microns, greater than or equal to 80 microns, greater than or equal to 90 microns, or greater than or equal to 100 microns. However, in some embodiments, the ultrasonic resonator and/or system for cutting a metal is configured to provide an amplitude less than or equal to 100 microns. In some embodiments, the ultrasonic resonator and/or system for cutting a metal is configured to provide an amplitude of less than or equal to 90 microns, less than or equal to 80 microns, less than or equal to 70 microns, less than or equal to 60 microns, less than or equal to 50 microns, less than or equal to 40 microns, less than or equal to 30 microns, less than or equal to 25 microns, less than or equal to 20 microns, less than or equal to 15 microns, or less than or equal to 10 microns. Combinations of the above-reference ranges are also possible (e.g., greater than or equal to 10 microns and less than or equal to 100 microns). Other ranges are possible.

In some embodiments, the ultrasonic resonator and/or system for cutting a metal is configured to provide a certain power. For example, in some embodiments, the ultrasonic resonator and/or system for cutting a metal operates with a power of greater than or equal to 150 W. In some embodiments, the ultrasonic resonator and/or system for cutting a metal operates with a power of greater than or equal to 150 W, greater than or equal to 200 W, greater than or equal to 400 W, greater than or equal to 500 W, greater than or equal to 600 W, greater than or equal to 800 W, greater than or equal to 900 W, greater than or equal to 1,000 W, greater than or equal to 1,200 W, greater than or equal to 1,500 W, greater than or equal to 1,800 W, greater than or equal to 2,000 W, greater than or equal to 2,500 W, greater than or equal to 3,000 W, greater than or equal to 3,500 W, greater than or equal to 4,000 W, or greater than or equal to 4,500 W. However, in some embodiments, the ultrasonic resonator and/or system for cutting a metal operates with a power of less than or equal to 4,500 W. In some embodiments, the ultrasonic resonator and/or system for cutting a metal operates with a power of less than or equal to 4,500 W, less than or equal to 4,000 W, less than or equal to 3,500 W, less than or equal to 3,000 W, less than or equal to 2,500 W, less than or equal to 2,000 W, less than or equal to 1,800 W, less than or equal to 1,500 W, less than or equal to 1,200 W, less than or equal to 1,000 W, less than or equal to 900 W, less than or equal to 800 W, less than or equal to 700 W, less than or equal to 600 W, less than or equal to 500 W, less than or equal to 400 W, less than or equal to 200 W, or less than or equal to 150 W. Combinations of the above referenced ranges are also possible (e.g., greater than or equal to 700 W and less than or equal to 2,500 W). Other ranges are possible. Selecting a particular power may advantageously provide enough energy to the blade (e.g., the die) to cut a particular metal of a certain hardness, and those skilled in the art based on the teachings of this disclosure will be able to select an appropriate power to ultrasonically cut a metal.

The ultrasonic resonator can include or be attached to a blade or die. Accordingly, the systems and methods can perform ultrasonic cutting with the blade or die. For instance, an ultrasonic resonator connected to the blade or die can provide ultrasonic cutting such that the blade or die is adapted and arranged for ultrasonic resonation. However, in some embodiments, an anvil provides ultrasonic resonation while the blade or die cuts the metal. The blade or die can, for example, cut a metal (e.g., a soft metal), such as lithium metal. The blade or die may be of any suitable shape or size for cutting a particular metal. For example, in some embodiments, the blade or die can be a symmetric blade. An example of a symmetric blade or die is blade or die 140, which is connected to ultrasonic resonator 110, schematically illustrated in FIG. 1B. While FIG. 1B depicts a symmetric blade or die, in some other embodiments, an asymmetric blade or die may also be used, as schematically illustrated in some embodiments below. Other blade configurations and geometries are also possible.

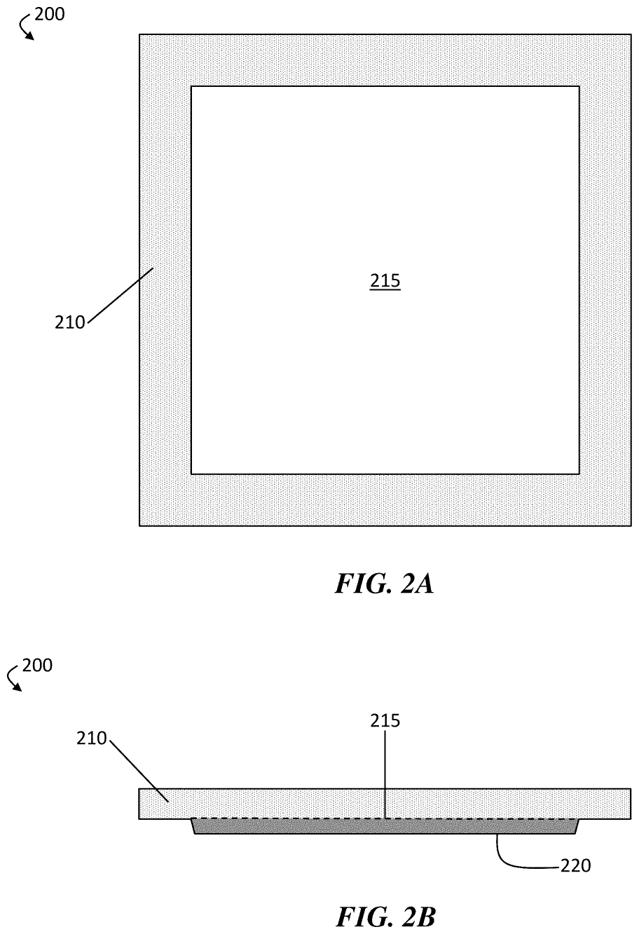

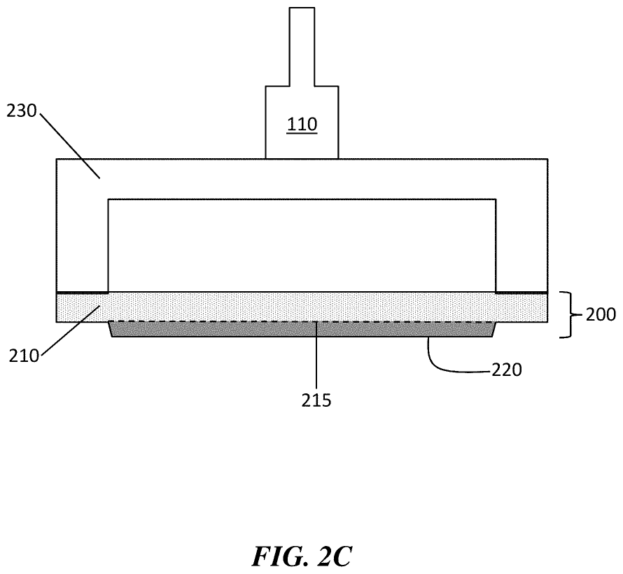

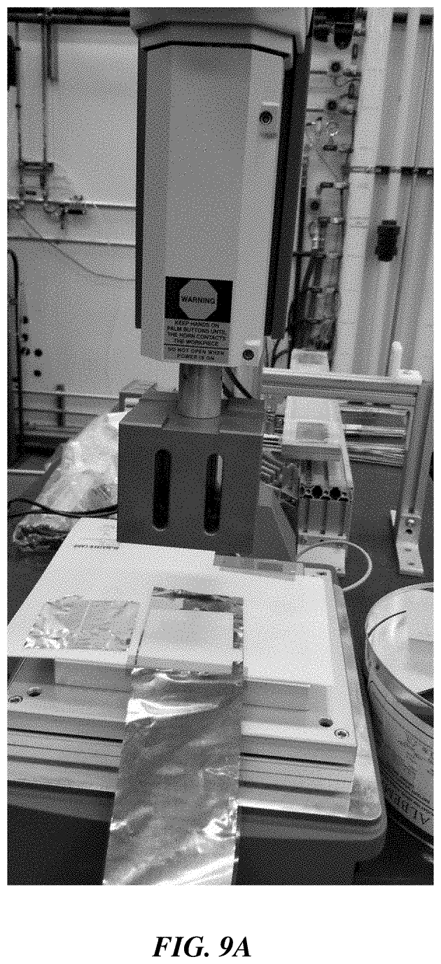

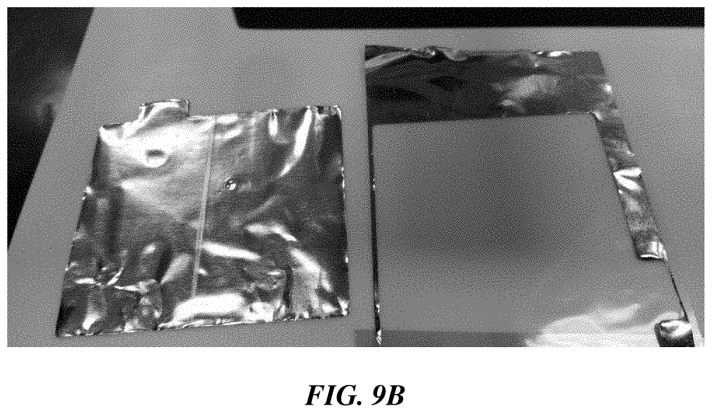

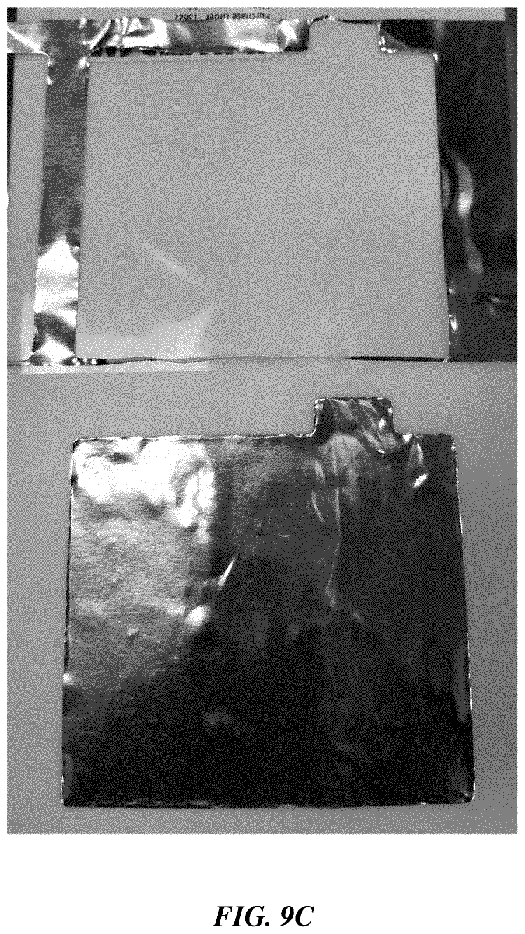

As noted above, in some embodiments, the blade is a die. In some such embodiments, the die is configured to cut the metal in a closed shape. For example, in FIG. 2A, a die 200 is schematically depicted from a top view. An open portion of the die forms closed shape 215 in a stencil-like fashion with a die edge 210. FIG. 2B shows a schematic side view of die 200. From this view, a cutting edge 220 of die 200 can be seen. When the cutting edge 220 is pressed into a metal (e.g., a soft metal), it can be used to plunge cut the metal in the shape of closed shape 215. FIGS. 9A-9B also show a metal cut with a die to form a cut portion of the metal in a closed shape formed by the die, and a remaining cut out portion of the metal. While FIG. 2 and FIG. 9 depict the die cutting (e.g., plunge cutting) in a closed shape, it should be understood that, in some embodiments, a blade can be used to trace or pattern a closed shape in the metal in order to cut a shape (e.g., the closed shape) in the metal. In such an embodiment, the blade (e.g., a single blade) and/or the ultrasonic resonator may be mounted on a movable stage, which can trace out a shape in the metal, or, in some such embodiments, the blade may be fixed and the metal can be positioned on the movable stage and the metal can be moved to trace out the shape in the metal.

A die can be connected to an ultrasonic resonator so that the die can be used to ultrasonically cut a metal. For example, in FIG. 2C, die 200 is connected to ultrasonic resonator 110 via a structure 230 (e.g., a die connector). This allows ultrasonic resonator 110 to provide motion (e.g., ultrasonic motion) to die 200. Another example of a die connected to an ultrasonic resonator is shown in FIG. 9A. The structure may be configured to provide or enhance resonance to the system for cutting a metal and thus increase the motion of the die or the anvil. However, it should be understood that the anvil or the die may be a direct part of the ultrasonic resonator. In other words, structure 230 may be absent, in some embodiments, and the ultrasonic resonator may include the die as part of the ultrasonic resonator.

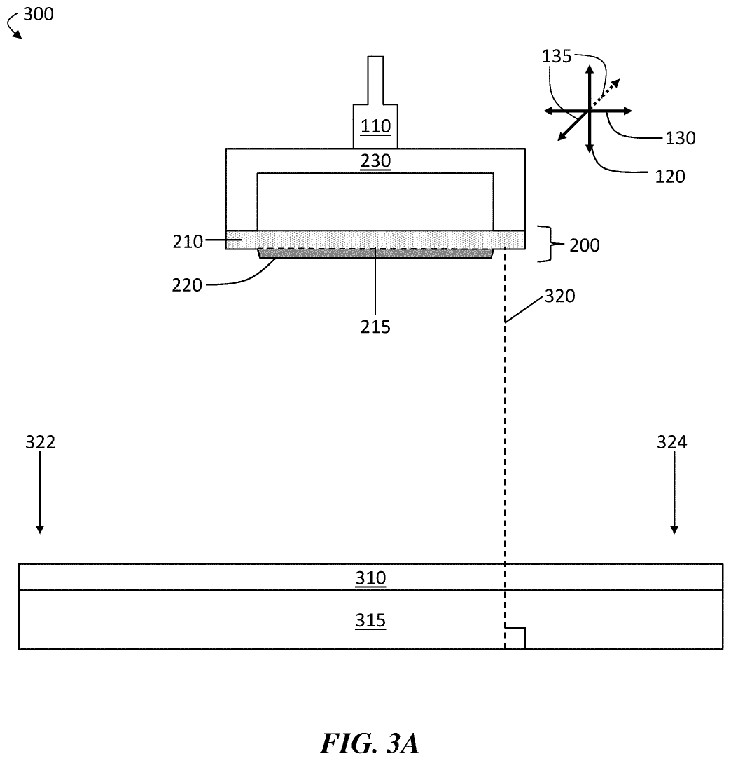

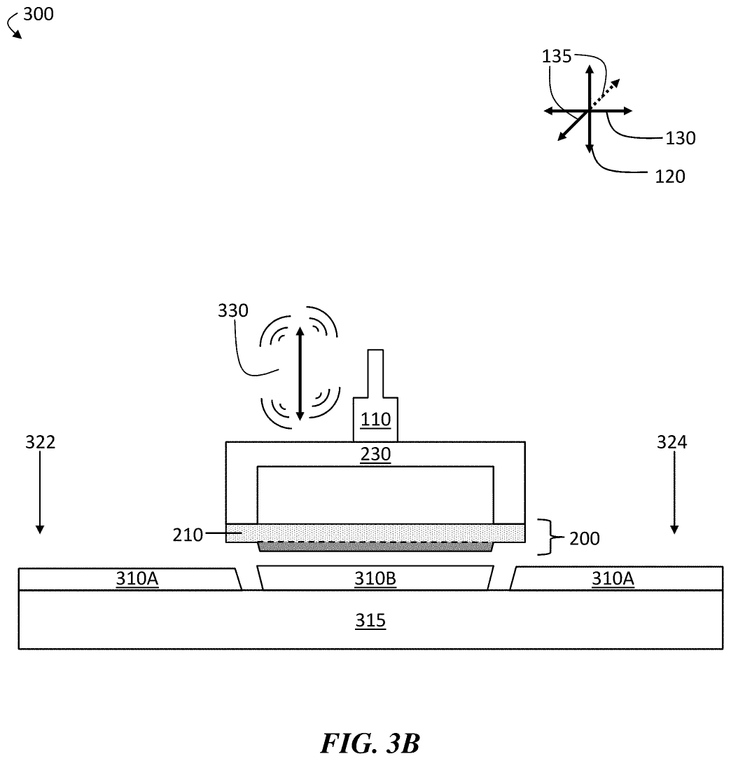

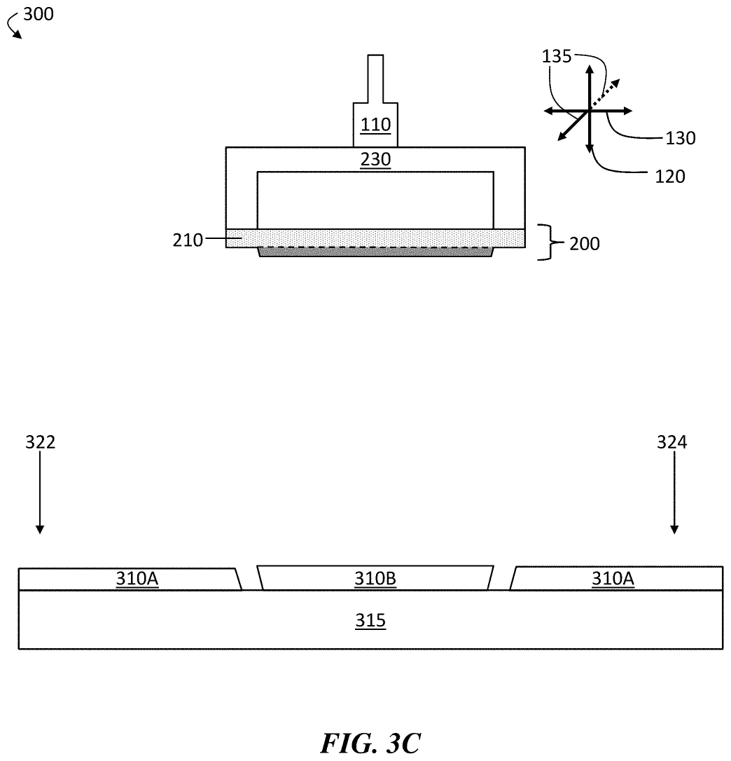

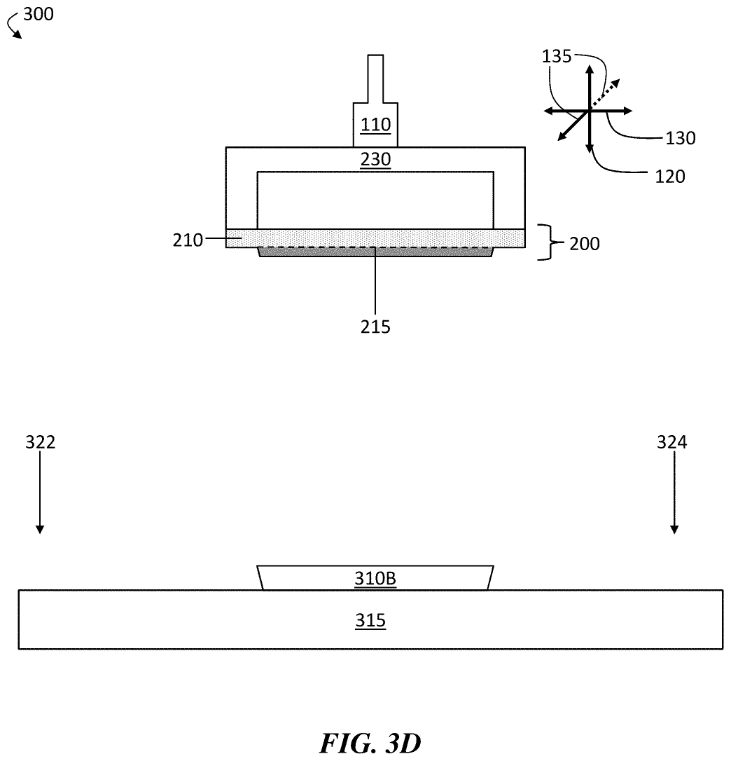

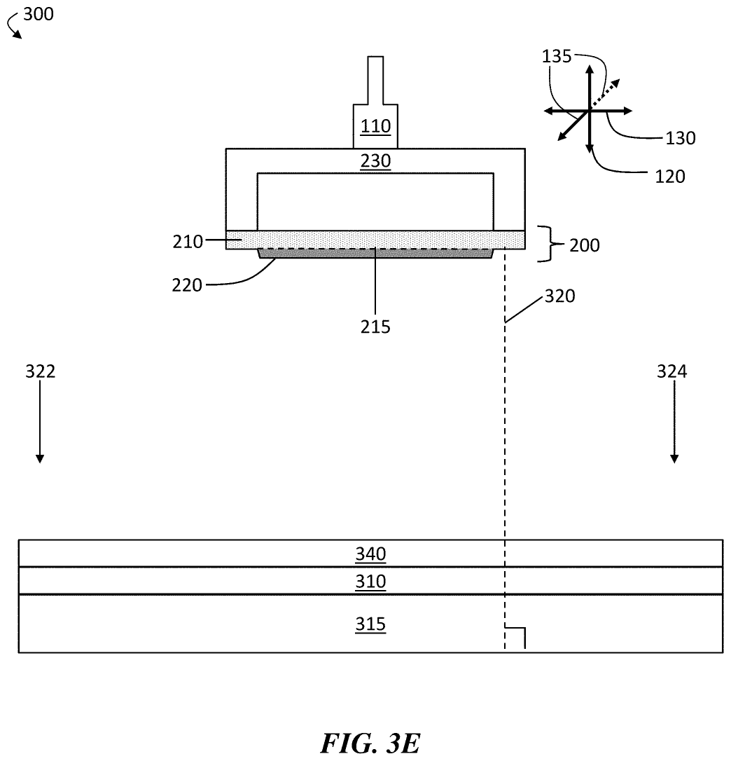

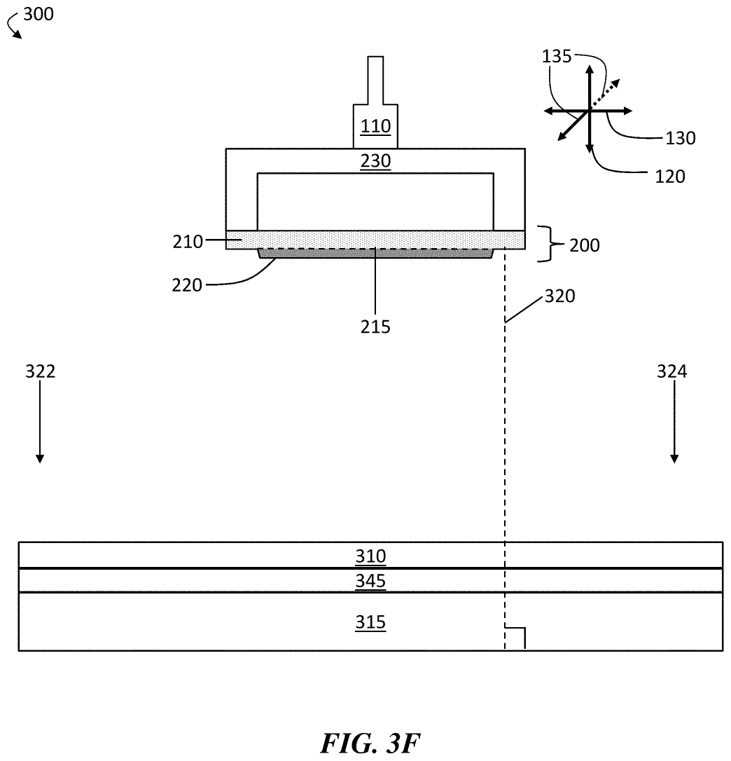

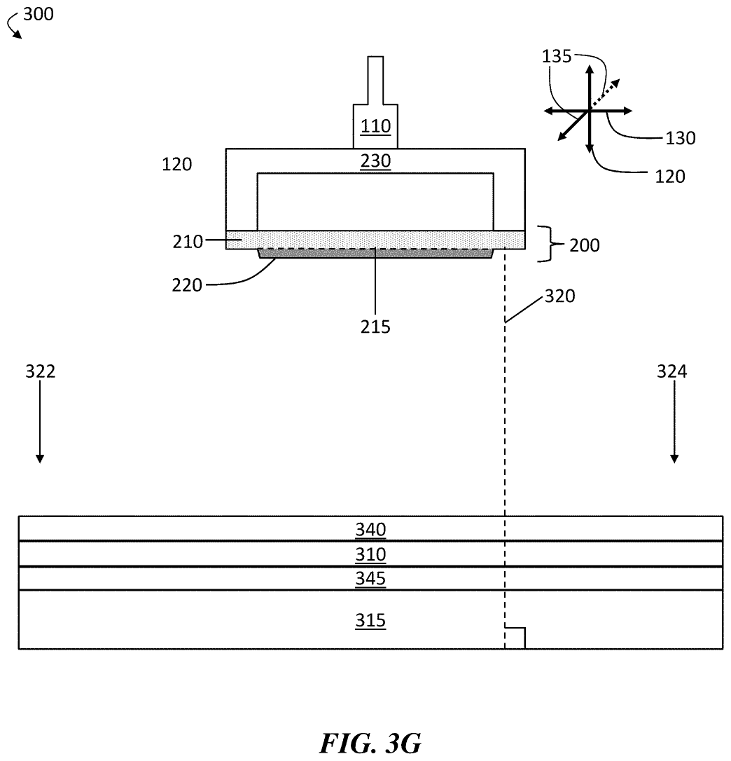

An example of a blade (e.g., a die) ultrasonically cutting a metal is now described in relation to FIGS. 3A-3D. A system for cutting 300 is schematically depicted in FIG. 3A. Ultrasonic resonator 110 is connected to die 200 via structure 230 (e.g., a die connector) and is positioned over a metal 310 and an anvil 315. Arrows 332 and 324 denote downstream and upstream positions, respectively. A perpendicular axis 320 is formed from die edge 210 to anvil 315. Perpendicular axis 320 is parallel to z-axis 120 and ultrasonic resonator 110 and die 200 can move along z-axis 120 toward metal 310. Die 200 can then ultrasonically plunge cut metal 310 with ultrasonic motion 330, as shown in FIG. 3B. In this process, metal 310 may be cut into two or more pieces. As shown illustratively in FIG. 3B, die 200 can be lifted and two pieces of metal 310A and 310B remain. Metal 310B has a shape complementary to closed shape 215 of die 200, while metal 310A has an open space that matches closed shape 215. Metal 310A can be removed (e.g., to a position further upstream or downstream), as shown illustratively in FIG. 3D leaving the cut metal 310B. In other embodiments, metal 310B can be removed (e.g., to a position further upstream or downstream), leaving metal 310A. In some embodiments, the cut metal can be used for a particular application, such as an anode in a lithium battery.

In addition to the blade or die, some embodiments may include at least one polymeric layer (e.g., an interleaf layer, a battery separator layer) adjacent the metal before, during, or after ultrasonically cutting the metal. Some embodiments comprise positioning a polymeric layer 340 (e.g., a first polymeric layer, a second polymeric layer) above the metal (e.g., metal layer 310), as shown illustratively in FIG. 3E. In some embodiments, the polymeric layer is positioned below the metal, as schematically illustrated in FIG. 3F. For example, in relation to FIG. 3F, a (bottom) polymeric layer 345 is positioned between metal 310 and anvil 315. In some embodiments, a second polymeric layer can be positioned adjacent the metal. For example, in FIG. 3G, (top) polymeric layer 340 is positioned above metal 310, while (bottom) polymeric layer 345 is positioned below metal 310.

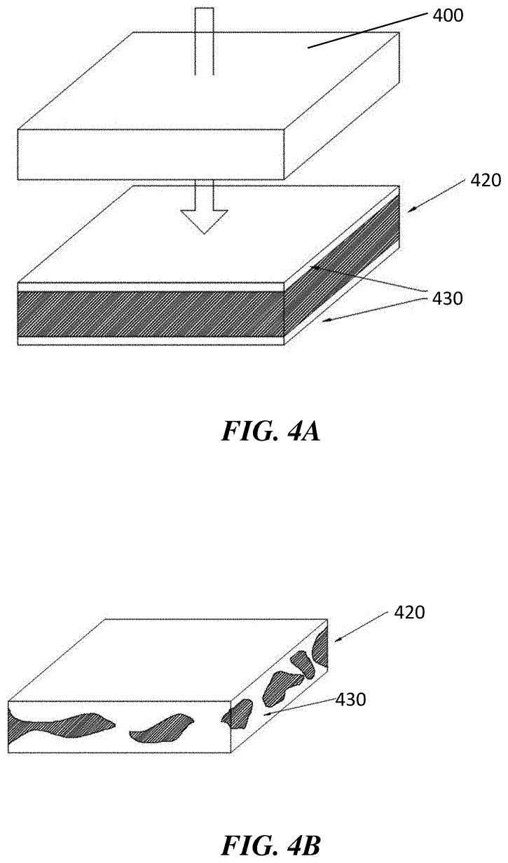

In some embodiments when a polymeric layer (e.g., an interleaf layer, a battery separator material layer) is positioned adjacent to the metal, the blade or die can ultrasonically cut the metal and the polymeric layer. For example, as illustrated schematically in FIGS. 4A-4B, die 400 is positioned above metal 420, with metal 420 between polymeric layers 430. While two polymeric layers 430 are shown in FIG. 4A, it should be understood that in some embodiments, only a single polymeric layer (e.g., above or below the metal) is present. Die 400 can move towards polymeric layer(s) 430 and metal 420 and ultrasonically cut polymeric layers 430 and the metal 420.

In some embodiments in which a first and a second polymer layer are present, the first polymeric layer and the second polymeric layer conformally envelope at least a portion the metal layer. For example, after the ultrasonic cutting schematically depicted in FIG. 4A, portions of metal 420 are surrounded by polymeric layers 430 as shown in the cross section in FIG. 4B. Although only portions but not all of the sides of metal 420 are covered by the polymeric layers in FIG. 4B, it should be appreciated that in other embodiments, all of the sides of metal 420 may be surrounded or enveloped by one or more polymeric layers.

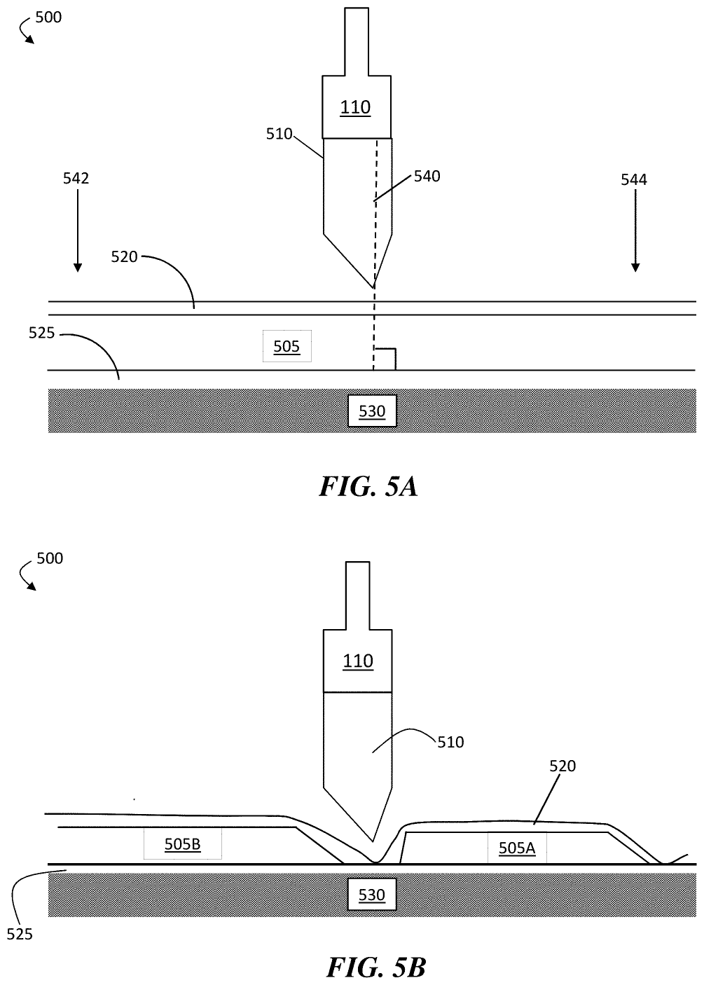

As noted above, in some embodiments, ultrasonic cutting does not cut a polymeric layer (e.g., an interleaf layer). For example, FIG. 5A schematically depicts a cross-section of a system 500 prior to cutting the metal. A metal 505 is positioned between a first polymeric layer 520 and a second polymeric layer 525. A blade 510 is connected to ultrasonic resonator 110 and positioned above first polymeric layer 520 and can be moved downward toward a substrate 530 along axis 540, which is defined by a line perpendicular to the substrate passing through the tip of the blade. The metal can be positioned relatively upstream, illustrated by arrow 542, and at least partially positioned downstream as it is being cut, in the downstream location of arrow 544. The blade 510 is lowered such that it ultrasonically plunge cuts metal 505 into two pieces 505A and 505B without cutting first polymeric layer 520, as shown illustratively in FIG. 5B. FIGS. 5A and 5B show blade 510 having an asymmetric configuration; however, it should be understood that a symmetric blade or other blade configurations can be used in other embodiments.

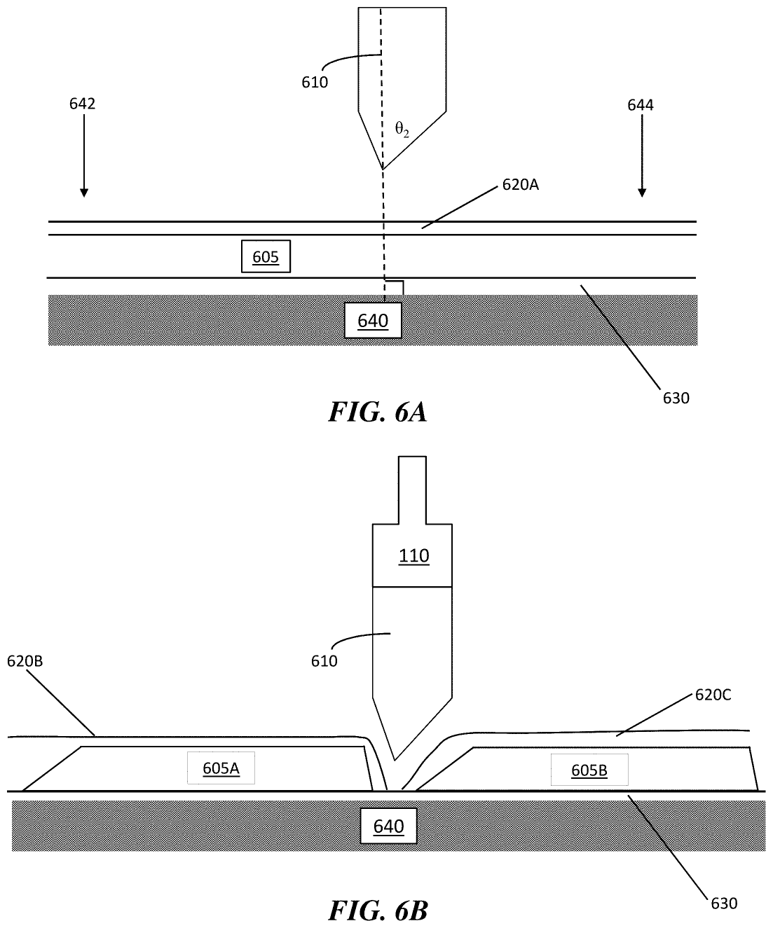

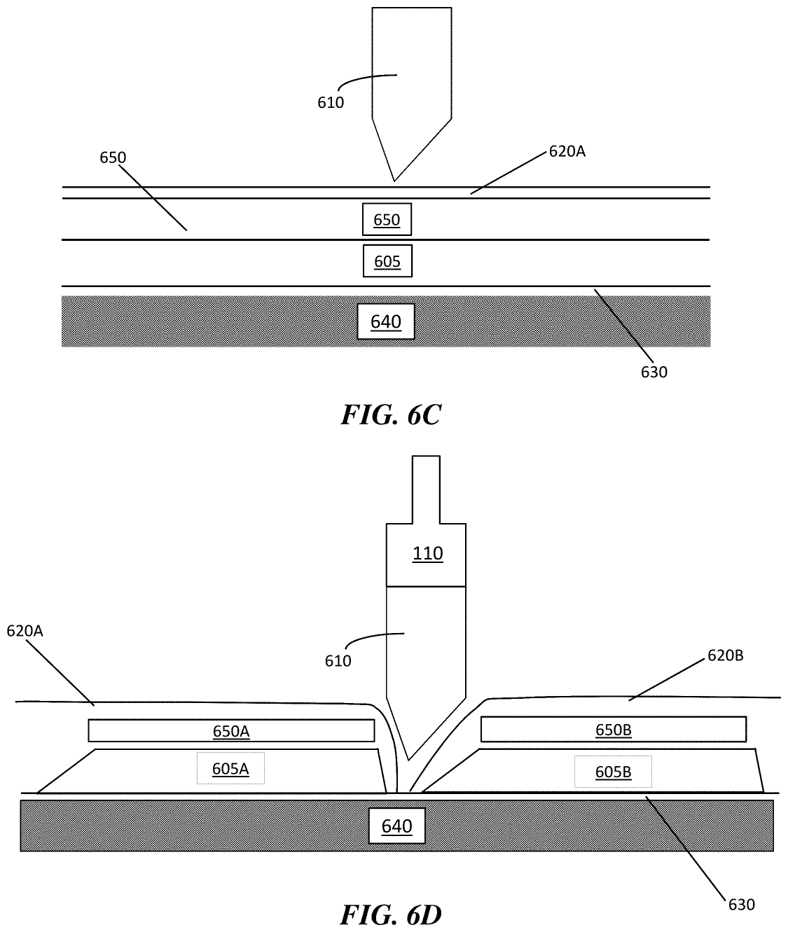

In some embodiments, the blade (e.g., the die) can ultrasonically cut a first polymeric layer (e.g., a top interleaf) and the metal without cutting a second polymeric layer (e.g., a bottom interleaf). Referring now to FIG. 6A, a blade 610 is connected to ultrasonic resonator 100 and is positioned such that first angle 614 (e.g., a smaller angle) is positioned towards upstream position 642 and a second angle 612 (e.g., a larger angle) now positioned towards downstream position 644. Metal 605 is positioned between a first polymeric layer 620A and a second polymeric layer 630. This configuration can allow the blade to ultrasonically cut the first polymeric layer. The blade can be lowered towards substrate 640 and cuts the first polymeric layer 620A into first polymeric layer piece 620B and second polymeric layer piece 620C, as shown in FIG. 6B. In addition, metal 605 is cut into metal piece 605A metal piece 605B. While FIG. 6A shows blade 610 having an asymmetric configuration, it should be understood that a symmetric blade or other blade configurations can be used in other embodiments.

In some embodiments, an optional protective layer may be present in the stack or layer(s) being cut. This optional protective layer may be adjacent (e.g., directly adjacent) to the metal being cut. A protective layer can act as a permeation barrier by decreasing the direct flow of species (e.g., Li ions) to the electroactive material layer (e.g., lithium metal), since these species have a tendency to diffuse through defects or open spaces in the layers. Consequently, dendrite formation, self-discharge, and loss of cycle life can be reduced. In some embodiments, the optional protective layer can be also be cut by the blade. For example, in relation to FIG. 6C, protective layer 650 is adjacent to metal 605. In some embodiments, the blade and the ultrasonic resonator can be configured to ultrasonically cut the protective layer and the first polymeric layer without cutting the second polymeric layer. For example, as schematically illustrated in FIG. 6D, blade 610 ultrasonically cuts first polymeric layer 620A, protective layer 650, and metal 605 without cutting second polymeric layer 630. While a single protective layer has been depicted in the figures, embodiments in which multiple protective layers, or a multilayer protective layer, are used are also envisioned. Additional details regarding protective layers are described elsewhere herein.

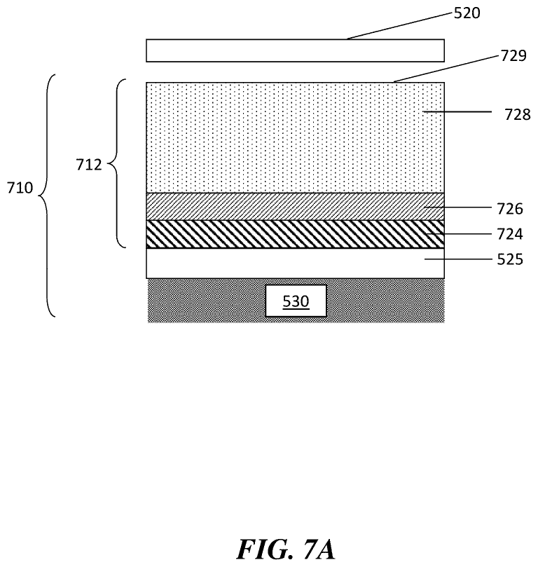

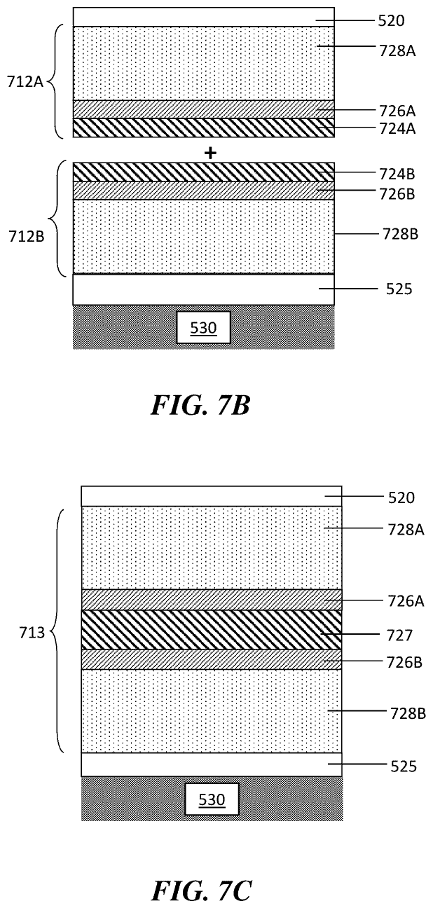

In some embodiments, an electrode assembly or composite electrode can be positioned between the first polymeric layer and the second polymeric layer, and the blade can be used to cut not only the electroactive material layer (e.g., soft metal), but also any layers adjacent to the electroactive material layer as part of a stacked assembly. As shown in the illustrative embodiment of FIG. 7A, an electrode assembly 710 includes several layers that are stacked together to form an electrode 712 (e.g., a lithium electrode, an anode, a cathode). For example, electrode 712 may be formed by optionally positioning or depositing one or more release layers 724 on a surface of the second polymeric layer 525, which is adjacent substrate 530 in the figure. As described in more detail below, the release layer serves to subsequently release the electrode from the substrate so it is not incorporated into the final electrochemical cell. To form the electrode, an electrode component such as an optional current collector 726 can be positioned or deposited adjacent the release layer and the release layer can be positioned adjacent to the second polymeric layer 525 and/or the substrate. Subsequently, an electroactive material layer 728 (e.g., a metal, lithium metal) can be positioned or deposited adjacent to current collector 726. In this embodiment, surface 729 of the electroactive layer may be positioned adjacent to the first polymeric layer, while the release layer 724 may be positioned adjacent to the second polymeric and/or a substrate. In this arrangement, the blade can ultrasonically cut assembly 712, which includes electroactive layer 728 (e.g., a soft metal). In some embodiments, the first polymeric layer is a battery separator material such that cutting the electroactive layer also results in cutting at least the first polymeric layer, resulting in an electrode assembly or electrode precursor that may be suitable for an electrochemical cell or a battery. It should be appreciated that while a release layer is shown in FIG. 7A, in some embodiments the release layer may be absent from the stacked assembly. It should also be appreciated that while current collector 726 is present in FIG. 7A, in other embodiments, the current collector may be absent from the stacked assembly such that the electroactive material layer is positioned directly on release layer 724.

After electrode assembly 710 has been formed, the second polymeric layer 525 can be released from the electrode through the use of release layer 724. Release layer 724 can be either released along with the polymeric layer so that the release layer is not a part of the final electrode structure, or the release layer may remain a part of the final electrode structure. The positioning of the release layer during release of the assembly from the polymeric layer can be varied by tailoring the chemical and/or physical properties of the release layer. For example, if it is desirable for the release layer to be part of the final electrode structure, the release layer can be tailored to have a greater adhesive affinity to current collector 726 relative to its adhesive affinity to second polymeric layer 525. On the other hand, if it is desirable for the release layer to not be part of an electrode structure, the release layer may be designed to have a greater adhesive affinity to second polymeric layer 525 relative to its adhesive affinity to current collector 726. In the latter case, when a peeling force is applied to second polymeric layer 525 (and/or to the electrode), the release layer is released from current collector 726 and remains on polymeric layer 525. While release layer 724 is adjacent to second polymeric layer 525 in FIG. 7A, it should also be appreciated that in other embodiments, the second polymeric layer may be absent such that release layer 724 is positioned directly on substrate 530 (or another component), and the above-described release characteristics are between the release layer and the substrate (or another component). It should also be appreciated that in embodiments in which current collector 726 is absent from the stacked assembly, release layer 724 may be positioned directly adjacent electroactive material layer 728. In some such embodiments, the release layer may remain attached to the electroactive material such that the release layer is a part of the final electrode assembly. In other embodiments, the release layer may be released from the electroactive material layer such that it does form a part of the final electrode assembly.

After cutting, first polymeric layer 520 may be removed from electrode assembly 710. However, in some embodiments, the first polymeric layer may be removed before cutting. In other embodiments, the first polymeric layer is not removed from the electrode assembly before and/or after cutting.

As noted above, in some embodiments, the stack or an electrode assembly is present between two polymeric layers. In some embodiments, the blade may cut through a stack or an electrode assembly, which can advantageously be used to cut pre-formed electrodes for batteries. In some embodiments, a thickness of a stack and/or an electrode assembly positioned between two polymeric layers (e.g., interleaf layers) is greater than or equal to 0.5 microns, greater than or equal to 1 micron, greater than or equal to 5 microns, greater than or equal to 10 microns, greater than or equal to 15 microns, greater than or equal to 20 microns, greater than or equal to 25 microns, greater than or equal to 30 microns, greater than or equal to 40 microns, greater than or equal to 50 microns, greater than or equal to 60 microns, greater than or equal to 70 microns, greater than or equal to 80 microns, greater than or equal to 90 microns, greater than or equal to 100 microns, greater than or equal to 200 microns, greater than or equal to 250 microns, greater than or equal to 500 microns, greater than or equal to 750 microns, or greater than or equal to 1000 microns. In some embodiments, a thickness of a stack and/or an electrode assembly positioned between two polymeric layers is less than or equal to 1000 microns, less than or equal to 750 microns, less than or equal to 500 microns, less than or equal to 250 microns, less than or equal to 100 microns, less than or equal to 90 microns, less than or equal to 80 microns, less than or equal to 70 microns, less than or equal to 60 microns, less than or equal to 50 microns, less than or equal to 40 microns, less than or equal to 30 microns, less than or equal to 25 microns, less than or equal to 20 microns, less than or equal to 15 microns, or less than or equal to 10 microns. Combinations of the above-referenced ranges are also possible (e.g., greater than or equal to 0.5 microns and less than or equal to 60 microns). Other ranges are also possible.

The blade or die can comprise a coating. The coating can be used, for example, to impart additional non-stick properties to the blade or die. In some embodiments, the coating comprising a PTFE (polytetrafluoroethylene) coating. Other coating materials include titanium nitride and diamond-like carbon (DLC) without limitation. In some embodiments, the blade or die comprises a ceramic coating. Any coating that provides a smooth and/or hard non-stick coating may be suitable as a blade or die coating. However, it should be noted that the coating on the blade or die can be used for other purposes other than non-stick properties, such as increasing smoothness or roughness of the blade or die, a passivating the surface of the blade or die, or other purposes.

A blade or die can have a surface roughness, e.g., a root mean square (RMS) surface roughness, of less than or equal to 1 micron and greater than or equal to 0.5 nm. In some embodiments, a layer has an RMS surface roughness of less than or equal to 1 micron, less than or equal to 500 nm, less than or equal to 100 nm, less than or equal to 50 nm, less than or equal to 25 nm, less than or equal to 10 nm, less than or equal to 5 nm, less than or equal to 1 nm, or less than or equal to 0.5 nm. In some embodiments, the blade or die has an RMS surface roughness of greater than or equal to 0.5 nm, greater than or equal to 1 nm, greater than or equal to 5 nm, greater than or equal to 10 nm, greater than or equal to 25 nm, greater than or equal to 50 nm, greater than or equal to 100 nm, greater than or equal to 500 nm, or greater than or equal to 1 micron. Combinations of the above-referenced range are also possible (e.g., less than or equal to 1 micron and greater than or equal to 0.5 nm). Other ranges are also possible.

The blade or die can comprise any suitable material for cutting a metal (e.g., a soft metal). The material of the blade can be selected to be suitably hard to cut the metal, but lightweight enough so that the blade or die is capable of ultrasonic resonation (e.g., at a particular frequency, power, or vibration) provided by the ultrasonic resonator. In some embodiments, the blade or die comprises a metal such as titanium, aluminum and/or steel. It can be beneficial to select a material of the blade or die that reduces or eliminates sticking of the blade to the metal. For example, in some embodiments, the blade or die comprises a polymer (e.g., a hard polymer) that does not stick to the blade, such a PTFE. In some embodiments, the blade or die comprises a ceramic material. Other materials are possible. In some embodiments, the blade can be serrated. However, in some embodiments, the blade is free of serrations.

As described above, the blade or die can be used to ultrasonically a metal. Accordingly, systems and methods described herein can include a metal (e.g., a metal foil, a metal alloy). In some embodiments, the metal is a soft metal. Some non-limiting examples of soft metals include lithium metal and other alkali metals, such as sodium (Na), potassium (K), cesium (Cs), and rubidium (Rb). The lithium metal can be a lithium metal alloy and/or can comprise vacuum deposited lithium metal. In some embodiments, the soft metal may be or may comprise indium. In some embodiments, systems and methods described may be suitable for cutting metals harder than the alkali metals, such as metal foils of aluminum. Other metals are possible. In some such embodiments, the metal foil has a thickness of less than or equal to 50 microns.

In some embodiments, the metal can be deposited using physical vapor deposition, sputtering, chemical deposition, electrochemical deposition, thermal evaporation, jet vapor deposition, laser ablation, or any other appropriate method. In an alternative embodiment, the metal (e.g., an electroactive material) is deposited on a protective layer by bonding the metal to the protective layer. In some such embodiments, a temporary bonding layer may be deposited onto the protective layer prior to bonding the metal layer, or the metal layer may bond directly to the protective layer. In some embodiments, the temporary bonding layer may form an alloy with the metal layer upon subsequent cycling of the electrode structure in an electrochemical cell. For example, silver and/or other metals that can alloy with lithium metal can be used in some embodiments.

The metal (e.g., metal foil) to be cut can comprise a particular softness. The softness of the metal can be measured using any suitable metric for measuring softness. For example, the softness of a metal can be characterized by the Young's modulus of the metal. In some embodiments, the metal to be cut comprises a Young's modulus of less than or equal to 130 GPa. In some embodiments, the metal to be cut comprises a Young's modulus of less than or equal to 120 GPa, less than or equal 110 GPa, less than or equal to 100 GPa, less than or equal to 75 GPa, less than or equal to 50 GPa, less than or equal to 25 GPa, less than or equal to 15 GPa, less than or equal to 12 GPa, less than or equal to 11 GPa, less than or equal to 10 GPa, less than or equal to 8 GPa, less than or equal to 5 GPa, less than or equal to 3 GPa, less than or equal to 2 GPa, or less than or equal to 1 GPa. In some embodiments, the metal to be cut comprises a Young's modulus of greater than or equal to 1 GPa, greater than or equal to 2 GPa, greater than or equal to 3 GPa, greater than or equal to 5 GPa, greater than or equal to 8 GPa, greater than or equal to 10 GPa, greater than or equal to 11 GPa, greater than or equal to 12 GPa, greater than or equal to 15 GPa, greater than or equal to 25 GPa, greater than or equal to 50 GPa, greater than or equal to 75 GPa, greater than or equal to 100 GPa, greater than or equal to 110 GPa, greater than or equal to 120 GPa, or greater than or equal to 130 GPa. Combinations of the above-referenced ranges are also possible (e.g., greater than or equal to 5 GPa and less than or equal to 130 GPa). Other ranges are possible. The Young's modulus can be measured by taking a length of material (e.g., metal) and applying a force to both ends to stretch the material. The amount the material stretches depends on the material's hardness. Stress on the material can be defined as force applied over the cross-sectional area, i.e., F/A, and where the strain is the relative length the material increases when stretched. If L₀ is the original length of the material and Lₙ is the stretched length, then strain is defined as (Lₙ−L₀)/Lₒ, and thus Young's modulus can be calculated by FL₀/A (Lₙ−L₀). Using certain conventional systems and methods to cut a metal can be difficult due to the hardness of the metal and can result in a cut with a rough or jagged edge. In some cases, cutting a metal with certain existing systems and methods can damage the blade. However, it has been recognized and appreciated by the Inventors within the context of this disclosure that metals (e.g., soft metals) can be cut (e.g., ultrasonically cut) with smooth edges and without damaging the blade.

The metal to be cut can be positioned in a number of suitable positions for cutting. For example, the metal can be positioned between the blade and the anvil, as schematically depicted in FIG. 3A, where lithium metal 310 is positioned between die 200 and anvil 315. The metal can be positioned below a polymeric layer, as schematically illustrated in FIG. 3E, where lithium metal 310 is positioned below top polymeric layer 340. In some embodiments, the metal is positioned above a polymeric layer, as shown in FIG. 3F, where lithium metal 310 is positioned above bottom polymeric layer 345. In some embodiments, the metal is positioned between a first polymeric layer and a second polymeric layer. An example of this positioning is shown in FIG. 3G, where lithium metal 310 is between top polymeric layer 340 and bottom polymeric layer 345. However, other positions of the metal are possible.

The thickness of the metal (e.g., a soft metal, lithium metal) may be selected depending on the size desired, for example, for an electrode in a battery, but generally may be selected to be thick enough to form an electrode, but thin enough to be cut by the blade. In some embodiments, a thickness of the metal is greater than or equal to 0.5 microns, greater than or equal to 1 micron, greater than or equal to 5 microns, greater than or equal to 10 microns, greater than or equal to 15 microns, greater than or equal to 20 microns, greater than or equal to 25 microns, greater than or equal to 30 microns, greater than or equal to 40 microns, greater than or equal to 50 microns, greater than or equal to 60 microns, greater than or equal to 70 microns, greater than or equal to 80 microns, greater than or equal to 90 microns, greater than or equal to 100 microns, greater than or equal to 250 microns, greater than or equal to 500 microns, or greater than or equal to 1000 microns. In some embodiments, a thickness of the metal is less than or equal to 1000 microns, less than or equal to 500 microns, less than or equal to 250 microns, less than or equal to 100 microns, less than or equal to 90 microns, less than or equal to 80 microns, less than or equal to 70 microns, less than or equal to 60 microns, less than or equal to 50 microns, less than or equal to 40 microns, less than or equal to 30 microns, less than or equal to 25 microns, less than or equal to 20 microns, less than or equal to 15 microns, less than or equal to 10 microns, less than or equal to 5 microns, less than or equal to 1 micron, or less than or equal to 0.5 microns. Combinations of the above-referenced ranges are also possible (e.g., greater than or equal to 0.5 microns and less than or equal to 20 microns, greater than or equal to 10 microns and less than or equal to 50 microns). Other ranges are possible.

In some embodiments, the metal has a low surface roughness, e.g., a root mean square (RMS) surface roughness of less than or equal to 1 micron, less than or equal to 500 nm, less than or equal to 100 nm, less than or equal to 50 nm, less than or equal to 25 nm, less than or equal to 10 nm, less than or equal to 5 nm, less than or equal to 1 nm, or less than or equal to 0.5 nm. Smoothness of the metal can be achieved, in some embodiments, by controlling vacuum deposition of the metal. The metal layer may be deposited onto a smooth surface (e.g., a smooth polymeric layer, a smooth current collector layer) having the same or a similar RMS surface roughness as the desired metal layer. Such and other methods can produce lithium metal layer(s) that are at least 1.5×, 2×, 3×, 4×, 5×, or even 10× smoother than certain commercially available foils, resulting in substantially uniformly-smooth surfaces.

As described herein, the metal to be cut for an electrochemical cell may comprise materials other than lithium metal. For example, in some embodiments, the electroactive material layer is a composite material t may be a component of an electroactive material layer. In other words, in some embodiments, an electroactive material layer comprises a metal. The electroactive material layer may be an electrode (e.g., a cathode, an anode (such as a lithium composite material).

In some embodiments, the electroactive material layer comprises a top surface, a bottom surface and a side surface between the top and bottom surfaces. The electroactive material can be positioned in a variety of positions. In some embodiments, the top surface is adjacent a first polymeric layer. In some embodiments, the bottom surface is adjacent to the second polymeric layer.

Systems and methods described herein can also include an anvil. The anvil can provide a surface for the metal to be cut to be held against before, during, or after ultrasonic cutting. In some embodiments, the anvil is adapted and arranged for ultrasonic resonation, such that ultrasonic motion can be provided by the anvil, while the blade cuts the metal. One example of an anvil adapted and arranged for ultrasonic resonation is shown in FIG. 1C, where anvil 145 is connect to ultrasonic resonator 110. In some embodiments, the anvil is adjacent to the blade.

The anvil can comprise a variety of materials suitable to support the metal to be cut. For example, in some embodiment, the anvil comprises titanium. Other materials are possible.

As described herein, the disclosed articles, systems, and methods may comprise one or more polymeric layers (e.g., a first polymeric layer, a second polymeric layer). Polymeric layers may be positioned adjacent (e.g., directly adjacent) or proximate to other components, such as the blade, the anvil, the metal, other polymeric layers, and/or the electroactive material layer. In some embodiments, at least a portion of the polymeric layer (e.g., the first polymeric layer, the second polymeric layer) covers at least a portion of a side surface of the electroactive material layer. The polymeric layer can comprise a variety of materials, the details of which are described below.

The polymeric material may comprise one or more polymers (e.g., it may be polymeric, it may be formed of one or more polymers). Examples of suitable polymeric materials include, but are not limited to, polyolefins (e.g., polyethylenes, poly(butene-1), poly(n-pentene-2), polypropylene, polytetrafluoroethylene); polyamines (e.g., poly(ethylene imine) and polypropylene imine (PPI)); polyamides (e.g., polyamide (Nylon), poly(ϵ-caprolactam) (Nylon 6), poly(hexamethylene adipamide) (Nylon 66)); polyimides (e.g., polyimide, polynitrile, and poly(pyromellitimide-1,4-diphenyl ether) (Kapton®) (NOMEX®) (KEVLAR®)); polyether ether ketone (PEEK); vinyl polymers (e.g., polyacrylamide, poly(2-vinyl pyridine), poly(N-vinylpyrrolidone), poly(methylcyanoacrylate), poly(ethylcyanoacrylate), poly(butylcyanoacrylate), poly(isobutylcyanoacrylate), poly(vinyl acetate), poly(vinyl alcohol), poly(vinyl chloride), poly(vinyl fluoride), poly(2-vinyl pyridine), vinyl polymer, polychlorotrifluoro ethylene, and poly(isohexylcyanoacrylate)); polyacetals; polyesters (e.g., polycarbonate, polybutylene terephthalate, polyhydroxybutyrate); polyethers (poly(ethylene oxide) (PEO), poly(propylene oxide) (PPO), poly(tetramethylene oxide) (PTMO)); vinylidene polymers (e.g., polyisobutylene, poly(methyl styrene), poly(methylmethacrylate) (PMMA), poly(vinylidene chloride), and poly(vinylidene fluoride)); polyaramides (e.g., poly(imino-1,3-phenylene iminoisophthaloyl) and poly(imino-1,4-phenylene iminoterephthaloyl)); polyheteroaromatic compounds (e.g., polybenzimidazole (PBI), polybenzobisoxazole (PBO) and polybenzobisthiazole (PBT)); polyheterocyclic compounds (e.g., polypyrrole); polyurethanes; phenolic polymers (e.g., phenol-formaldehyde); polyalkynes (e.g., polyacetylene); polydienes (e.g., 1,2-polybutadiene, cis or trans-1,4-polybutadiene); polysiloxanes (e.g., poly(dimethylsiloxane) (PDMS), poly(diethylsiloxane) (PDES), polydiphenylsiloxane (PDPS), and polymethylphenylsiloxane (PMPS)); and inorganic polymers (e.g., polyphosphazene, polyphosphonate, polysilanes, polysilazanes). In some embodiments, the polymer may be selected from poly(n-pentene-2), polypropylene, polytetrafluoroethylene, polyamides (e.g., polyamide (Nylon), poly(ϵ-caprolactam) (Nylon 6), poly(hexamethylene adipamide) (Nylon 66)), polyimides (e.g., polynitrile, and poly(pyromellitimide-1,4-diphenyl ether) (Kapton®) (NOMEX®) (KEVLAR®)), polyether ether ketone (PEEK), and combinations thereof.

In some embodiments, the polymeric layer (e.g., a first polymeric layer, a second polymeric layer) is an interleaf layer (e.g., a first interleaf layer, a second interleaf layer). The interleaf layer can be used to prevent or reduce the amount of direct contact that the blade and/or the anvil makes with the metal. The interleaf layer can also prevent excess metal from accumulating on the blade. In some embodiments, the interleaf layer comprises a polymeric material, such as those describe above and elsewhere herein. For some embodiments, more than one polymeric layer may be provided; for example, two polymeric layers (e.g., a top interleaf layer, a bottom interleaf layer) may be provided whereby the top polymeric layer is positioned adjacent a top surface of the metal and the bottom polymeric layer can be positioned on a bottom surface of the metal, but above the substrate or the anvil. In some embodiments, the polymeric layer is not cut by the blade during ultrasonic cutting. In other embodiments, the polymeric layer can be cut by ultrasonic cutting.

In some embodiments, the one or more polymeric layers comprises a battery separator material. In some cases, at least two polymeric layers (e.g., separators/separator layers) may be included and may conformally envelope at least a portion of the metal (e.g., lithium metal). The separator layer(s) can be configured to inhibit (e.g., prevent) physical contact between two electrodes (e.g., between an anode and a cathode, between a first electrode and a second electrode), which could result in short circuiting of the electrochemical cell. The separator can be configured to be substantially electronically non-conductive, which can inhibit the degree to which the separator causes short circuiting of the electrochemical cell. In some embodiments, all or portions of the separator can be formed of a material with a bulk electronic resistivity of greater than or equal to 10⁴, greater than or equal to 10⁵, greater than or equal to 10¹⁰, greater than or equal to 10¹⁵, or greater than or equal to 10²⁰ Ohm-meters. The bulk electronic resistivity may be measured at room temperature (e.g., 25° C.). In such embodiments, ultrasonically cutting the metal can also cut the battery separator, which can advantageously produce electrode stacks that can be readily assembled with other electrode materials (e.g., a cathode) in order to fabricate an electrochemical cell or lithium battery.

In some embodiments, the battery separator material can be ionically conductive, while in other embodiments, the separator is substantially ionically non-conductive. In some embodiments, the average ionic conductivity of the separator is greater than or equal to 10⁻⁷ S/cm, greater than or equal to 10⁻⁶ S/cm, greater than or equal to 10⁻⁵ S/cm, greater than or equal to 10⁻⁴ S/cm, greater than or equal to 10⁻² S/cm, or greater than or equal to 10⁻¹ S/cm. In certain embodiments, the average ionic conductivity of the separator may be less than or equal to 1 S/cm, less than or equal to 10⁻¹ S/cm, less than or equal to 10⁻² S/cm, less than or equal to 10⁻³ S/cm, less than or equal to 10⁻⁴ S/cm, less than or equal to 10⁻⁵ S/cm, less than or equal to 10⁻⁶ S/cm, less than or equal to 10⁻⁷ S/cm, or less than or equal to 10⁻⁸ S/cm. Combinations of the above-referenced ranges are also possible (e.g., an average ionic conductivity of greater than or equal to 10⁻⁸ S/cm and less than or equal to 10⁻¹ S/cm). Other values of ionic conductivity are also possible.

The average ionic conductivity of the battery separator material can be determined by employing a conductivity bridge (i.e., an impedance measuring circuit) to measure the average resistivity of the separator at a series of increasing pressures until the average resistivity of the separator does not change as the pressure is increased. This value is considered to be the average resistivity of the separator, and its inverse is considered to be the average conductivity of the separator. The conductivity bridge may be operated at 1 kHz. The pressure may be applied to the separator in 500 kg/cm² increments by two copper cylinders positioned on opposite sides of the separator that are capable of applying a pressure to the separator of greater than or equal to 3 tons/cm². The average ionic conductivity may be measured at room temperature (e.g., 25° C.).

In some embodiments, the battery separator material can be a solid. The separator may be sufficiently porous such that it allows an electrolyte solvent to pass through it. In some embodiments, the separator does not substantially include a solvent (e.g., it may be unlike a gel that comprises solvent throughout its bulk), except for solvent that may pass through or reside in the pores of the separator. In other embodiments, a separator may be in the form of a gel.

In some embodiments, a polymeric layer (e.g. a first polymeric layer, a second polymeric layer, an interleaf layer) may be of a suitable thickness to allow the metal layer and/or the polymeric layer to be cut. For example, in some embodiments a thickness of the polymeric layer is greater than or equal to 5 microns, greater than or equal to 10 microns, greater than or equal to 25 microns, greater than or equal to 50 microns, greater than or equal to 75 microns, greater than or equal to 100 microns, greater than or equal to 150 microns, greater than or equal to 200 microns, or greater than or equal to 250 microns. In some embodiments, a thickness of the polymeric layer is less than or equal to 250 microns, less than or equal to 200 microns, less than or equal to 150 microns, less than or equal to 100 microns, less than or equal to 75 microns, less than or equal to 50 microns, less than or equal to 25 microns, less than or equal to 10 microns, or less than or equal to 5 microns. Combinations of the above-referenced ranges are also possible (e.g., greater than or equal to 5 microns and less than or equal to 250 microns). Other ranges are also possible.

In some embodiments, the thickness of a polymeric layer (e.g., an interleaf layer) can be selected to have a ratio relative to a thickness of the metal. In some embodiments, the ratio of a thickness of a polymeric layer to a thickness of the metal is less than or equal to 10:1, less than or equal to 7:1, less than or equal to 5:1, less than or equal to 4:1, less than or equal to 3:1, less than or equal 2:1, or less than or equal to 1:1. In some embodiments, the ratio of a thickness of the polymeric layer to the thickness of the metal is greater than or equal to 1:1, greater than or equal to 2:1, greater than or equal to 3:1, greater than or equal to 4:1, greater than or equal to 5:1, greater than or equal to 7:1, or greater than or equal to 10:1. Combinations of the above-referenced ranges are possible (e.g., greater than or equal to 1:1 and less than or equal to 5:1). Other ranges are possible.

In some embodiments, a polymeric layer has a surface roughness, e.g., a root mean square (RMS) surface roughness, of less than or equal to 1 micron and greater than or equal to 0.5 nm. In some embodiments, a layer has an RMS surface roughness of less than or equal to 1 micron, less than or equal to 500 nm, less than or equal to 100 nm, less than or equal to 50 nm, less than or equal to 25 nm, less than or equal to 10 nm, less than or equal to 5 nm, less than or equal to 1 nm, or less than or equal to 0.5 nm. In some embodiments, a polymeric layer has an RMS surface roughness of greater than or equal to 0.5 nm, greater than or equal to 1 nm, greater than or equal to 5 nm, greater than or equal to 10 nm, greater than or equal to 25 nm, greater than or equal to 50 nm, greater than or equal to 100 nm, greater than or equal to 500 nm, or greater than or equal to 1 micron. Combinations of the above-referenced range are also possible (e.g. less than or equal to 1 micron and greater than or equal to 0.5 nm). Other ranges are possible.

In some embodiments, a polymeric layer (e.g., a release layer) may include one or more crosslinking agents. A crosslinking agent is a molecule with a reactive portion(s) designed to interact with functional groups on the polymer chains in a manner that will form a crosslinking bond between one or more polymer chains. Examples of crosslinking agents that can crosslink polymeric materials used for release layers and/or adhesion promoters described herein include, but are not limited to: polyamide-epichlorohydrin (polycup 172); aldehydes (e.g., formaldehyde and urea-formaldehyde); dialdehydes (e.g., glyoxal glutaraldehyde, and hydroxyadipaldehyde); acrylates (e.g., ethylene glycol diacrylate, di(ethylene glycol) diacrylate, tetra(ethylene glycol) diacrylate, methacrylates, ethelyne glycol dimethacrylate, di(ethylene glycol) dimethacrylate, tri(ethylene glycol) dimethacrylate); amides (e.g., N,N′-methylenebisacrylamide, N,N′-methylenebisacrylamide, N,N′-(1,2-dihydroxyethylene)bisacrylamide, N-(1-hydroxy-2,2-dimethoxyethyl)acrylamide); silanes (e.g., methyltrimethoxysilane, methyltriethoxysilane, tetramethoxysilane (TMOS), tetraethoxysilane (TEOS), tetrapropoxysilane, methyltris(methylethyldetoxime)silane, methyltris(acetoxime)silane, methyltris(methylisobutylketoxime)silane, dimethyldi(methylethyldetoxime)silane, trimethyl(methylethylketoxime)silane, vinyltris(methylethylketoxime)silane, methylvinyldi(mtheylethylketoxime)silane, methylvinyldi(cyclohexaneoneoxxime)silane, vinyltris(mtehylisobutylketoxime)silane, methyltriacetoxysilane, tetraacetoxysilane, and phenyltris(methylethylketoxime)silane); divinylbenzene; melamine; zirconium ammonium carbonate; dicyclohexylcarbodiimide/dimethylaminopyridine (DCC/DMAP); 2-chloropyridinium ion; 1-hydroxycyclohexylphenyl ketone; acetophenon dimethylketal; benzoylmethyl ether; aryl triflourovinyl ethers; benzocyclobutenes; phenolic resins (e.g., condensates of phenol with formaldehyde and lower alcohols, such as methanol, ethanol, butanol, and isobutanol), epoxides; melamine resins (e.g., condensates of melamine with formaldehyde and lower alcohols, such as methanol, ethanol, butanol, and isobutanol); polyisocyanates; dialdehydes; and other crosslinking agents known to those of ordinary skill in the art.

In some embodiments in which the polymeric layer is a release layer, the thickness of the release layer may be between greater than or equal to 0.001 microns and less than or equal to 50 microns. In some embodiments, a release layer has a thickness of greater than or equal to 0.001 microns, greater than or equal to 1 micron, greater than or equal to 2 microns, greater than or equal to 3 microns, greater than or equal to 5 microns, greater than or equal to 10 microns, greater than or equal to 20 microns, or greater than or equal to 50 microns. In some embodiments, the thickness of a release layer is less than or equal to 50 microns, less than or equal to 20 microns, less than or equal to 10 microns, less than or equal to 5 microns, less than or equal to 3 microns, less than or equal to 2 microns, less than or equal to 1 micron, or less than or equal to 0.001 microns. Combinations of the above-referenced ranges are possible (e.g., greater than or equal to 2 microns and less than or equal to 20 microns). Other ranges are possible. In embodiments in which more than one release layers are present, each release layer may independently have a thickness in one or more of the above-referenced ranges.

In embodiments including a crosslinked polymeric material and a crosslinking agent, the weight ratio of the polymeric material to the crosslinking agent may vary for a variety of reasons including, but not limited to, the functional-group content of the polymer, its molecular weight, the reactivity and functionality of the crosslinking agent, the desired rate of crosslinking, the degree of stiffness/hardness desired in the polymeric material, and the temperature at which the crosslinking reaction may occur. Non-limiting examples of ranges of weight ratios between the polymeric material and the crosslinking agent include from 100:1 to 50:1, from 20:1 to 1:1, from 10:1 to 2:1, and from 8:1 to 4:1.

The adhesive strength between two layers described herein, such as between a metal layer and a polymeric layer (e.g., a first polymeric layer, a second polymeric layer, an interleaf layer), between a protective layer and a polymeric layer, between a current collector and a polymeric layer, and/or between a polymeric layer and a substrate, can be tailored as desired. To determine relative adhesion strength between two layers, a tape test can be performed. Briefly, the tape test utilizes pressure-sensitive tape to qualitatively assess the adhesion between a first layer (e.g., an interleaf layer) and a second layer (e.g., a lithium metal layer). In such a test, an X-cut can be made through the first layer to the second layer. Pressure-sensitive tape can be applied over the cut area and removed. If the first layer stays on the second layer, adhesion is good. If the first layer comes off with the strip of tape, adhesion is poor. The tape test may be performed according to the standard ASTM D3359-02. In some embodiments, a strength of adhesion between a first layer (e.g., an interleaf layer) and a second layer (e.g., a lithium metal layer, a current collector, a protective layer, a substrate) passes the tape test according to the standard ASTM D3359-02, meaning the second layer does not delaminate from the first layer during the test. In some embodiments, the tape test is performed after the two layers have been included in a cell, such as a lithium-ion cell or any other appropriate cell described herein, that has been cycled greater than or equal to 5 times, greater than or equal to 10 times, greater than or equal to 15 times, greater than or equal to 20 times, greater than or equal to 50 times, or greater than or equal to 100 times, and the two layers pass the tape test after being removed from the cell (e.g., the first layer does not delaminate from the second layer during the test).

The peel test may include measuring the adhesiveness or force required to remove a first layer (e.g., a polymeric layer, an interleaf layer) from a unit area of a surface of a second layer (e.g., a metal, a metal layer), which can be measured in N/m, using a tensile testing apparatus or another suitable apparatus. Such experiments can optionally be performed in the presence of a solvent (e.g., an electrolyte) or other components to determine the influence of the solvent and/or components on adhesion.

In some embodiments, the strength of adhesion between two layers may range, for example, between 100 N/m to 2000 N/m. In certain embodiments, the strength of adhesion may be greater than or equal to 50 N/m, greater than or equal to 100 N/m, greater than or equal to 200 N/m, greater than or equal to 350 N/m, greater than or equal to 500 N/m, greater than or equal to 700 N/m, greater than or equal to 900 N/m, greater than or equal to 1000 N/m, greater than or equal to 1200 N/m, greater than or equal to 1400 N/m, greater than or equal to 1600 N/m, or greater than or equal to 1800 N/m. In certain embodiments, the strength of adhesion may be less than or equal to 2000 N/m, less than or equal to 1500 N/m, less than or equal to 1000 N/m, less than or equal to 900 N/m, less than or equal to 700 N/m, less than or equal to 500 N/m, less than or equal to 350 N/m, less than or equal to 200 N/m, less than or equal to 100 N/m, or less than or equal to 50 N/m. Combinations of the above-referenced ranges are also possible. Other strengths of adhesion are also possible.

As described above, the systems and methods described herein may cut (e.g., ultrasonically cut) a metal (and optionally, other layers associated with the metal such as one or more polymeric layers). In some embodiments, ultrasonically cutting the metal comprises a blade or die connected to an ultrasonic resonator. However, in some embodiments, ultrasonic cutting comprises the ultrasonic resonator connected to an anvil and a blade cuts the metal while the anvil moves ultrasonically. In some embodiments, the blade penetrates a layer of metal so as to plunge cut the metal. The metal can have at least one polymeric layer adjacent the metal or an adjacent polymeric layer may be absent. In some embodiments, a first polymeric layer (e.g., a top interleaf layer) can contact a second polymeric layer when the blade cuts the metal. In some embodiments, the first polymeric layer is not cut during this process, while metal is cut. However, in other embodiments, the first polymeric layer is cut, in addition to the metal. In some embodiments, a depth of penetration of the blade relative to the metal and/or the first polymeric layer can contribute in determining if the first polymeric layer is cut. Those skilled in the art will be capable of determining an appropriate depth of penetration of the blade in cutting or not cutting through the first polymeric layer in view of systems and methods described herein.

By way of example and not limitation, the blade or die can penetrate (e.g., cut) the first polymeric layer (e.g., top interleaf layer) by greater than or equal to 5% of a thickness of the first polymeric layer, greater than or equal to 10% of a thickness of the first polymeric layer, greater than or equal to 20% of the thickness of the first polymeric layer, greater than or equal to 40% of a thickness of the first polymeric layer, greater than or equal to 60% of a thickness of the first polymeric layer, greater than or equal to 80% of a thickness of the first polymeric layer, greater than or equal to 90% of a thickness of the first polymeric layer, greater than or equal to 95% of a thickness of the first polymeric layer, greater than or equal to 99% of a thickness of the first polymeric layer, or 100% of a thickness of the first polymeric layer. In some embodiments, the blade may penetrate (e.g., cut) the first polymeric layer by less than or equal to 100% of a thickness of the first polymeric layer, less than or equal to 99% of a thickness of the first polymeric layer, less than or equal to 95% of a thickness of the first polymeric layer, less than or equal to 90% of a thickness of the first polymeric layer, less than or equal to 80% of a thickness of the first polymeric layer, less than or equal to 60% of a thickness of the first polymeric layer, less than or equal to 40% of a thickness of the first polymeric layer, less than or equal to 20% of a thickness of the first polymeric layer, less than or equal to 10% of a thickness of the first polymeric layer, or less than or equal to 5% of a thickness of the first polymeric layer. Combinations of the above-referenced ranges are also possible (e.g., greater than or equal to 5% of a thickness of the first polymeric layer and less than or equal to 80% of a thickness of the first polymeric layer). Other ranges are possible.

In some embodiments, the blade or die contacts the second polymeric layer (e.g., a bottom interleaf layer), or may stop before contacting the second polymeric layer, but does not cut the second polymeric layer during the cutting step. However, in other embodiments, the second polymeric layer is cut by the blade or die. In some embodiments, the second polymeric layer is cut by an amount within one or more of the ranges above as for the first polymeric layer.

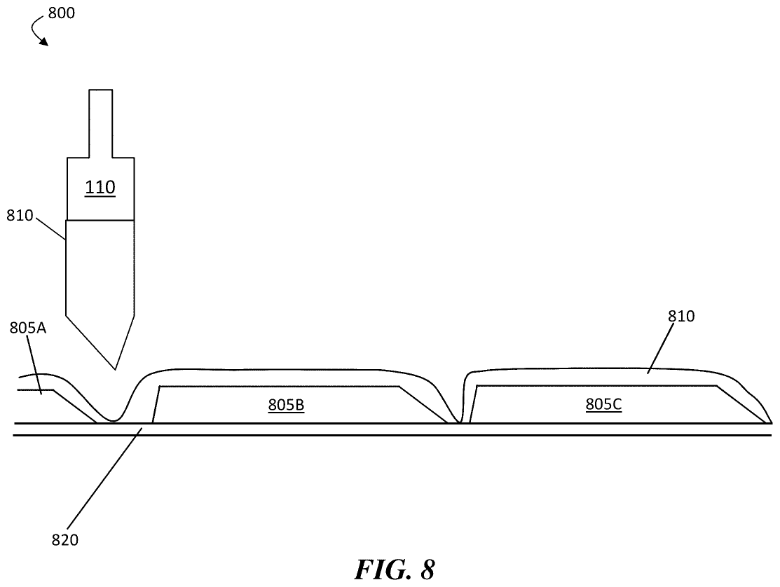

After ultrasonically cutting (e.g., plunge cutting) the metal, the cut metal can be sealed with at least one polymeric layer. In some embodiments, the blade and/or the motion of the blade may facilitate sealing of the at least one polymeric layer. In some embodiments, the first polymeric layer, the metal, and the second polymeric layer are sealed to form a stack after ultrasonically cutting. In some embodiments, sealing comprises staking or adhering a portion of the metal to a polymeric layer. For example, in reference to FIG. 8, blade 810 cuts the lithium metal while not cutting a first polymeric layer 810 nor a second polymeric layer 820. The first polymeric layer 810 adheres to the second polymeric layer 820 and seals lithium metal pieces 805A, 805B, and 805C. In some embodiments, sealing comprises melting a portion of a first polymeric layer and/or a second polymeric layer and adhering the first polymeric layer to the second polymeric layer. Sealing may conformally envelop the polymeric layer around the metal (e.g., lithium metal). For example, in FIG. 8, lithium metal pieces 805B and 805C have been sealed on both ends and form an envelope-like structure. While FIG. 8 depicts sealing of both ends of lithium metal pieces 805B and 805C, in other embodiments, the metal can be sealed in another manner.

In some embodiments, the first polymeric layer, the metal, and the second polymeric layer are positioned adjacent to a cathode (e.g., a lithium intercalation compound) after ultrasonically cutting. Positioning the first polymeric layer, the metal, and the second polymeric layer adjacent to a cathode can facilitate forming a stack assembly, an electrochemical cell, or an electrode precursor for a battery.

In order to facilitate removal of the cut metal from the blade or die a force may be applied after the cutting step. Removing the cut metal may be used to help preassemble an electrochemical cell or battery, for example, in an assembly line up. In some embodiments, the method comprises applying a force to the metal after the cutting step. A variety of forces can be used to dislodge the metal if it remains within the closed shape of a die. In some embodiments, the force is a jet of gas (e.g., air). In some embodiments, the force is an ultrasonic burst. In such embodiments using an ultrasonic burst, the ultrasonic burst is generated by the ultrasonic resonator. In some embodiments, an optional blower is present, which can blow a fluid (e.g., compressed air, nitrogen gas, argon), to move the cut metal. However, in some embodiments, the metal does not require an additional force to remove after cutting.

In some embodiments, a polymeric layer can be removed from the metal after cutting the metal. Removal of the polymeric layer can be accomplished in a variety of ways, including by use of vacuum. In some cases, a cut piece of metal can be removed after being cut. For example, the metal can be moved to a downstream position after the polymeric layer has been removed from the cut piece of metal. Removal of the cut piece of metal can be accomplished using a vacuum apparatus or any other suitable method for removing the metal from a substrate, the anvil, or a second polymeric layer.

Additional details regarding articles, systems, and methods described above are provided below.

In some embodiments, an electrode precursor material can be formed using the blade or die. The blade or die may be configured to cut the metal layer while leaving a polymeric layer uncut by the blade or die. The blade or die can then cause the (first) polymeric layer and/or the metal to adhere to the (second) polymeric layer, which may result in the cut metal layer to be pinched, enveloped, and/or surrounded by the polymeric layer(s).

In some embodiments, an optional protective layer may be present. This optional protective layer may be adjacent to a polymeric layer or a metal layer. The optional protective layer(s) may be made from any suitable material capable of acting as a protective layer for the underlying electrode structure (e.g., a lithium metal layer). In some embodiments, the material of the protective layer is conductive to the electroactive species (e.g., Li-ions). The protective layer may also be referred to as a “single-ion conductive material layer,” in some instances. In some embodiments, the protective layer is a solid. In some embodiments, the protective layer comprises or may be substantially formed of a non-polymeric material. For example, the protective layer may comprise or may be substantially formed of an inorganic material. Depending on the particular embodiment, the protective layer may be either electrically insulating or electrically conducting. In some embodiments, the protective layer is a ceramic, a glassy-ceramic, or a glass. Additional suitable materials for the protective layer may include, but are not limited to, lithium nitride, lithium silicate, lithium borate, lithium aluminate, lithium phosphate, lithium phosphorus oxynitride, lithium silicosulfide, lithium germanosulfide, lithium oxides (e.g., Li₂O, LiO, LiO₂, LiRO₂, where R is a rare earth metal), lithium lanthanum oxides, lithium titanium oxides, lithium borosulfide, lithium aluminosulfide, lithium phosphosulfide, and combinations thereof.

A protective layer may be deposited by any suitable method such as sputtering, electron beam evaporation, vacuum thermal evaporation, laser ablation, chemical vapor deposition (CVD), thermal evaporation, plasma enhanced chemical vacuum deposition (PECVD), laser enhanced chemical vapor deposition, aerosol deposition, and jet vapor deposition. The technique used may depend on the type of material being deposited, the thickness of the layer, etc.

In some embodiments, a protective layer that includes some porosity can be treated with a polymer or other material such that the pores (e.g., nanopores) of the protective layer may be filled with the polymer. Examples of techniques for forming such structures are described in more detail in U.S. patent aplication Ser. No. 12/862,528, filed on Aug. 24, 2010, published as U.S. Pub. No. 2011/0177398, entitled “Electrochemical Cell”, which is incorporated herein by reference in its entirety for all purposes.

Additionally or alternatively, in some embodiments, the protective layer may be a polymer layer that is conductive to the electroactive species. Suitable polymers include, but are not limited to, both electrically conducting and electrically insulating ion conduction polymers. Possible electrically conducting polymers include, but are not limited to, poly(acetylene)s, poly(pyrrole)s, poly(thiophene)s, poly(aniline)s, poly(fluorene)s, polynaphthalenes, poly(p-phenylene sulfide), and poly(para-phenylene vinylene)s. Possible electrically insulating polymers include, but are not limited to, acrylate, polyethyleneoxide, silicones, and polyvinylchlorides. In some embodiments, the polymer(s) is present in a non-swollen state (e.g., as a thin film), such as in configurations in which the protective layer comprising the polymer is separated from the electrolyte by a ceramic, glass or glassy-ceramic layer. The above polymers may be doped with ion conducting salts to provide, or enhance, the desired ion conducting properties. Appropriate salts for lithium based cells include, for example, LiSCN, LiBr, LiI, LiClO₄, LiAsF₆, LiSO₃CF₃, LiSO₃CH₃, LiBF₄, LiB(Ph)₄, LiPF₆, LiC(SO₂CF₃)₃, and LiN(SO₂CF₃)₂ though other salts may be used for other chemistries. The above materials may be deposited using spin casting, doctor blading, flash evaporation, or any other appropriate deposition technique. In some embodiments, a protective layer is formed of, or includes, a suitable polymeric material, optionally with modified molecular weight, cross-linking density, and/or addition of additives or other components. In embodiments in which more than one protective layer is present, each protective layer may each independently comprise one or more of the above-referenced materials.

In some embodiments, the thickness of the protective layer may be less than or equal to 5 μm, less than or equal to 2 μm, less than or equal to 1.5 μm, less than or equal to 1.4 μm, less than or equal to 1.3 μm, less than or equal to 1.2 μm, less than or equal to 1.1 μm, less than or equal to 1 μm, less than or equal to 0.9 μm, less than or equal to 0.8 μm, less than or equal to 0.7 μm, less than or equal to 0.6 μm, less than or equal to 0.5 μm, less than or equal to 0.4 μm, less than or equal to 0.3 μm, less than or equal to 0.2 μm, less than or equal to 0.1 μm, less than or equal to 50 nm, less than or equal to 30 nm, or any other appropriate thickness. Correspondingly, the thickness of the protective layer may be greater than or equal to 10 nm, greater than or equal to 30 nm, greater than or equal to 50 nm, greater than or equal to 0.1 μm, greater than or equal to 0.2 μm, greater than or equal to 0.3 μm, greater than or equal to 0.4 μm, greater than or equal to 0.6 μm, greater than or equal to 0.8 μm, greater than or equal to 1 μm, greater than or equal to 1.2 μm, greater than or equal to 1.4 μm, greater than or equal to 1.5 μm, or any other appropriate thickness. Combinations of the above are possible (e.g., a thickness of the protective layer may be less than or equal to 2 μm and greater than or equal to 0.1 μm). Other ranges are also possible. In embodiments in which more than one protective layer is present, each protective layer may each independently have a thickness in one or more of the above-referenced ranges.

As used herein, when a layer (e.g., a protective layer, a polymeric layer, a metal layer, an electroactive layer) is referred to as being “on” or “adjacent” another layer, it can be directly on or adjacent the layer, or an intervening layer may also be present. A layer that is “directly on”, “directly adjacent”, “in contact with”, or “in conformal contact with” another layer means that no intervening layer is present. Likewise, a layer that is positioned “between” two layers may be directly between the two layers such that no intervening layer is present, or an intervening layer may be present.

In some embodiments, a portion of a layer (e.g., a polymeric layer, a protective layer) and/or a sublayer of a protective layer may be deposited by an aerosol deposition process. Aerosol deposition processes are known in the art and generally comprise depositing (e.g., spraying) particles (e.g., inorganic particles, polymeric particles) at a relatively high velocity on a surface. Aerosol deposition, as described herein, generally results in the collision and/or elastic deformation of at least some of the plurality of particles. In some aspects, aerosol deposition can be carried out under conditions (e.g., using a velocity) sufficient to cause fusion of at least some of the plurality of particles to at least another portion of the plurality of particles. For example, in some embodiments, a plurality of particles is deposited on an electroactive material (and/or any sublayer(s) disposed thereon) at a relative high velocity such that at least a portion of the plurality of particles fuse (e.g., forming the portion and/or sublayer of the protective layer). The velocity required for particle fusion may depend on factors such as the material composition of the particles, the size of the particles, the Young's elastic modulus of the particles, and/or the yield strength of the particles or material forming the particles.

In some embodiments, the average ionic conductivity (e.g., lithium ion conductivity) of the protective layer is greater than or equal to 10⁻⁷ S/cm, greater than or equal to 10⁻⁶ S/cm, greater than or equal to 10⁻⁵ S/cm, greater than or equal to 10⁻⁴ S/cm, greater than or equal to 10⁻³ S/cm, greater than or equal to 10⁻² S/cm, greater than or equal to 10⁻¹ S/cm, greater than or equal to 1 S/cm, or greater than or equal to 10 S/cm. The average ionic conductivity may less than or equal to 20 S/cm, less than or equal to 10 S/cm, or less than or equal to 1 S/cm. Conductivity may be measured at room temperature (e.g., 25 degrees Celsius). In embodiments in which more than one protective layer is present, each protective layer may each independently have an ionic conductivity in one or more of the above-referenced ranges.

While a single protective layer has been depicted in the figures, embodiments in which multiple protective layers, or a multilayer protective layer, are used are also envisioned. Possible multilayer structures can include arrangements of polymer layers and single ion conductive layers as described in more detail in U.S. patent application Ser. No. 12/862,528, filed on Aug. 24, 2010, published as U.S. Pub. No. 2011/0177398, entitled “Electrochemical Cell”, which is incorporated herein by reference in its entirety for all purposes. For example, a multilayer protective layer may include alternating single-ion conductive layer(s) and polymer layer(s) in some embodiments. Other examples and configurations of possible multilayer structures are also described in more detail in U.S. patent application Ser. No. 11/400,781, filed Apr. 6, 2006, published as U.S. Pub. No. 2007-0221265, and entitled, “Rechargeable Lithium/Water, Lithium/Air Batteries” to Affinito et al., which is incorporated herein by reference in its entirety for all purposes.

A single layer or multilayer protective layer can act as a superior permeation barrier by decreasing the direct flow of species to the electroactive material layer, since these species have a tendency to diffuse through defects or open spaces in the layers. Consequently, dendrite formation, self-discharge, and loss of cycle life can be reduced. Another advantage of a protective layer includes the mechanical properties of the structure. For example, where both polymer and inorganic layers are present, the positioning of a polymer layer adjacent an inorganic conductive layer can decrease the tendency of the inorganic conductive layer to crack and can increase the barrier properties of the structure. Thus, these laminates may be more robust towards stress due to handling during the manufacturing process than structures without intervening polymer layers. In addition, a multilayer protective layer can also have an increased tolerance of the volumetric changes that accompany the migration of lithium back and forth from the electroactive material layer during the cycles of discharge and charge of the cell.

The following examples are intended to illustrate certain embodiments of the present invention, but do not exemplify the full scope of the invention.

### EXAMPLE 1

The following example describes a system and method for ultrasonically cutting portions of lithium foil with a blade in the form of a die attached to an ultrasonic resonator.

A horn (e.g., the ultrasonic resonator and the die) was mounted to a press, as shown in FIG. 9A. The press was used to move the horn up and down so that it was positioned to contact the anvil. The anvil was a flat steel plate adjacent to the horn. The anvil was covered with a polymeric layer (e.g., polyoxymethylene POM, polytetrafluoroethylene, polypropylene, polyethylene) to prevent the blade (die) from being dulled on the steel anvil. The up and down motion could be adjusted such that the die was a few mils from touching the anvil (1 to 5 mils).

The die pattern to be cut was machined on the bottom of the large die block. The block/die was configured to resonate with the ultrasonic resonator and to and amplify the ultrasonic motion. Due to the block's size, lower frequencies (i.e., higher power) were used to get the energy into the block. In this case the frequency was 20 kHz.

A 50-micron thick piece of lithium foil was positioned on top of the polymeric layer, which was adjacent the anvil. A slight amount of tension was applied to the polymeric layer to keep the material flat. The power supply was adjusted for the cut. The amplitude could be varied from 20% to 100%. The cut time could be varied from 0.01 to 100 seconds. In addition, delay and after burst times could also be set.

The cut was made in an automated manner. That is, the start button was activated, and the die was brought down by the press and contacted the foil, and the power was initiated and ran for the programmed time at the programmed amplitude. Then the die was retracted to its top position. After cutting the foil, the cut center piece (e.g., electrode portion) was then slid away from the scrap foil, which had a cut-out shape complementary to the die pattern of the block, as shown in FIG. 9B and FIG. 9C. In FIG. 9C, it was observed that neither the cut piece nor the foil around it was sticking to the blade/die. It was also observed that cutting the shape and removing it from scrap foil left very thin slivers of very delicate material remaining on the scraps and they did not stick to the cut piece or break from scrap foil during the cutting process.

In some cases, if the portion of the cut foil had stuck to the die, then a short burst after cutting could be applied to shake the cut portion loose. This could also be programmed (e.g., into the press) to occur from 0.01 to 10 seconds and could be initiated after the ultrasonic cutting pulses, but before the die was raised back to its top position, so that the cut part remained on the anvil.

After cutting, any kind of suitable mechanical component or vacuum could pick up and place the cut lithium foil to safely transport the part to the cell stack.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A system for cutting a metal electrode, comprising:
a blade;
an ultrasonic resonator connected to the blade; and
a metal to be cut having a Young's modulus of less than or equal to 130 GPa.

2. A system for cutting a metal electrode, comprising:
a blade;
an anvil adjacent to the blade;
an ultrasonic resonator connected to the blade or the anvil; and
a metal positioned between the blade and the anvil.

3. (canceled)

4. A method of cutting a metal electrode, the method comprising:
positioning a metal between an anvil and a blade, wherein the blade or the anvil is connected to an ultrasonic resonator; and
ultrasonically cutting the metal with the blade.

5. (canceled)

6. The method of claim 4, wherein the method comprises sealing a first polymeric layer, the metal, and a second polymeric layer to form the stack after ultrasonically cutting.

7. The method of claim 6, wherein sealing comprises melting at least a portion of the first polymeric layer and/or the second polymeric layer and adhering the first polymeric layer to the second polymeric layer.

8. The method of claim 4, wherein the method comprises conformally enveloping at least a portion of the metal with a first polymeric layer and a second polymeric layer.

9. The method of claim 4, wherein the method comprises positioning an interleaf layer between the blade and the anvil.

10. The method of claim 4, wherein cutting the metal comprises plunge cutting the metal.

11. The method of claim 4, wherein the method comprises positioning a first polymeric layer, the metal, and a second polymeric layer on a cathode after ultrasonically cutting.

12. The method of claim 4, wherein the method comprises applying a force of less than or equal to 2000 N/m to the metal after the cutting step.

13. The method of claim 12, wherein the force comprises a jet of gas or air generated by a blower, and/or an ultrasonic burst generated by the ultrasonic resonator.

14. The system of claim 1, wherein the metal to be cut has a Young's modulus of greater than or equal to 5 GPa.

15. The system of claim 1, wherein the metal comprises lithium metal, a lithium metal alloy, vacuum-deposited lithium metal, and/or a metal foil.

16. The system of claim 1, further comprising a first interleaf layer disposed between the metal and the blade and/or a second interleaf layer disposed between the anvil and the metal.

17. The system of claim 1, wherein the blade is a die, the die optionally configured to cut the metal in a closed shape.

18-20. (canceled)

21. The system of claim 1, wherein the blade is a symmetric blade or an asymmetric blade.

22. The system of claim 1, wherein the blade comprises a metal, such as titanium, aluminum, and/or steel, a polymer, such as a hard polymer, and/or a ceramic.

23. The system of claim 1, wherein the blade is free of serrations

24-25. (canceled)

26. The system of claim 1, wherein the ultrasonic resonator is configured to move in an axis perpendicular to the anvil and the blade.

27. The system of claim 1, wherein the ultrasonic resonator is configured to move in three dimensions.

28-32. (canceled)
